(19) United States
(12) Patent Application Publication
(10) Pub. No.: US 2026/0221035 A1
(43) Pub. Date: Jul. 30, 2026

(54) FORECASTING MANAGED FACILITY DEMAND USING MACHINE LEARNING

(71) Applicant: Metropolis IP Holdings, LLC, Santa Monica, CA (US)

(72) Inventors: Cameron McQuary Blume, San Jose, CA (US); Nathaniel Lounsbury, Barton, NY (US); Barry James O'Brien, Seattle, WA (US); Ji Sung Hwang, Albany, CA (US)

(21) Appl. No.: 19/040,689

(22) Filed: Jan. 29, 2025

(51) Int. Cl. G08G 1/14; G06Q 30/0202; G06Q 50/40; G07C 9/10

(52) U.S. Cl. CPC G08G 1/149; G06Q 30/0202; G06Q 50/40; G07C 9/10

(57) ABSTRACT

A method or system for predicting vehicular occupancy of a managed facility is disclosed. A system receives a request for projected vehicular occupancy at a managed facility during a time range and determines a predicted regional vehicular occupancy within a geographic region encompassing the managed facility during the time range. The system retrieves a set of dynamic environmental parameters corresponding to the managed facility and inputs the predicted regional vehicular occupancy, the environmental parameters, and the time range to a machine learning model. The system receives a predicted measure of vehicular occupancy at the managed facility during the time range from the machine learning model. The system outputs a control signal instructing a device associated with the managed facility to perform an operation based on the predicted measure of vehicular occupancy.

### TECHNICAL FIELD

The disclosure generally relates to machine learning, and more particularly relates to application of machine learning models to predict vehicle demand at a managed facility.

### BACKGROUND

A managed facility, such as a parking lot, airport, stadium, or commercial complex, typically includes fixtures, expensive hardware, and other resources for users of the managed facility to access while within a physical space of the managed facility. The managed facility may provide power to these resources continuously to be prepared for an instance when a user visits the physical space. However, the managed facility may waste power and its other resources in doing so if resources remain unused for continuous stretches of time. Without an ability to forecast demand for the physical space, the managed facility may continue to erroneously waste its resources that could be saved for busier time periods. While managed facilities may want to offer more parking or provide certain vehicular services when parking demand is high, determining parking demand in advance is difficult due to the breadth of the factors that affect the determination. Thus, to enable managed facilities to allocate resource use effectively, a system for determining demand for physical space within managed facilities is necessary.

### SUMMARY

The embodiments described herein address the above-described issues of existing vehicle management systems by using machine learning models to predict vehicular occupancy and vehicular duration at managed facilities, which are used to output control signals that impact resource allocation. A managed facility can request (e.g., via an operator) an expected occupancy and duration of occupancy of its physical space at a time. Based on the request, a system can select characteristics of the managed facility that may affect occupancy and duration of occupancy at the managed facility, such as events that bring large quantities of people to the area around the managed facility, typical traffic patterns in the area, what the managed facility provides (e.g., events, goods, leisure space, etc.), and the like. The system uses one or more machine learning models to predict expected occupancy and duration of occupancy of the physical space at the time. To account for the prediction, the system may take an action at the managed facility, such as disabling or enabling resources available to users of the physical space, thus allowing the managed facility optimize resource utilization.

In some embodiments, a method or system for predicting vehicular occupancy and occupancy duration of a managed facility is disclosed. In some embodiments, a system receives a request for projected vehicular occupancy at a managed facility during a time range and determines a predicted regional vehicular occupancy within a geographic region encompassing the managed facility during the time range. The system retrieves a set of dynamic environmental parameters corresponding to the managed facility and inputs the predicted regional vehicular occupancy, the environmental parameters, and the time range to a machine learning model. The system receives a predicted measure of vehicular occupancy at the managed facility during the time range from the machine learning model. The system outputs a control signal instructing a device associated with the managed facility to perform an operation based on the predicted measure of vehicular occupancy.

The control signal may instruct machinery within the managed facility to perform one or more actions. For instance, the control signal may instruct a mechanical barrier to block off or unblock a section of the managed facility from vehicles, cause a sign to alter what is displayed based on the predicted measure of vehicular occupancy or occupancy duration of the managed facility, cause one or more of vehicle chargers to turn on or off, and/or cause one or more mechanical and electrical systems to configure to guide vehicles to an unblocked section of the managed facility selected based on the predicted measure of vehicular occupancy and/or predicted measure of vehicular duration. The control signal may also cause a notification to be transmitted to one or more client devices indicating the predicted measure of vehicular occupancy or occupancy duration of the managed facility, an updated schedule for employees of the managed facility based on the predicted measure of vehicular occupancy and/or occupancy duration, or an indication of expected availability at the managed facility based on the based on the predicted measure of vehicular occupancy and/or occupancy duration.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

Figure (FIG. 1) illustrates an example system environment for managing vehicle parking or transit through a managed facility, using an edge device and a vehicle management server, in accordance with one or more embodiments.

FIG. 2 illustrates an example architecture of an edge device, in accordance with one or more embodiments.

FIG. 3 illustrates an example architecture of a vehicle management server, in accordance with one or more embodiments.

FIG. 4 illustrates an example architecture of a prediction module, in accordance with one or more embodiments.

FIG. 5 illustrates an example flow of a managed facility module being used to predict vehicular occupancy and vehicular duration, in accordance with one or more embodiments.

FIG. 6 is a block diagram illustrating components of an example machine able to read instructions from a machine-readable medium and execute them in a processor (or controller) in accordance with one or more embodiments.

FIG. 7A is a flowchart of a method for outputting a control signal based on a predicted measure of vehicular occupancy of a managed facility, in accordance with one or more embodiments.

FIG. 7B is a flowchart of a method for outputting a control signal based on a predicted measure of vehicular duration at a managed facility, in accordance with one or more embodiments.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

Vehicle management systems may be employed for traffic and occupancy management within managed facilities. These systems may use one or more machine learning models to predict a measure of demand for vehicular occupancy at a managed facility and duration of occupancy at the managed facility. A managed facility may be a building or site associated with a business, organization, or other group and may be overseen by associated personnel to ensure efficient and satisfactory use of the managed facility. Within a managed facility, a vehicle management system may be configured to use environmental parameters describing the conditions around and characteristics of the managed facility as input to a machine learning model. The output from the machine learning model may describe predicted vehicular occupancy and/or occupancy duration at the managed facility and may be used to determine a control signal to send to a device associated with the managed facility.

The vehicle management system may predict either or both of regional vehicular occupancy and vehicular occupancy. Vehicular occupancy is an indication of the proportion of physical space that is occupied or otherwise in use and may be represented by a number of spaces in use or not in use or by a percentage of space available for use or not available for use. The regional vehicular occupancy represents the percentage of vehicular space in use within a geographic region, whereas vehicular occupancy represents the percentage of vehicular space in use at a managed facility.

The vehicle management system may predict regional vehicular occupancy with a model, which may be a machine learning model. The model receives, as input, environmental parameters describing the geographic region that the managed facility is located within. The term environmental parameters, as used herein, may refer to parameters that may impact usage and/or duration of occupancy of a managed facility. Environmental parameters describe special events that impact vehicular occupancy during a time period associated with the special event. Examples of special events in the geographic region of Seattle include Seahawks games, commuting hours, and tourist season at Pike Place. The model may use these environmental parameters to determine regional vehicular occupancy during a specific time period. For example, the model may predict a much larger regional vehicular occupancy during work hours compared to the midnight. The vehicle management system may input this prediction to a machine learning model specific to the managed facility. The machine learning model may be configured to output a prediction of vehicular occupancy or occupancy duration (e.g., how long a vehicle is stopped) at the managed facility for the time period.

The prediction(s) by the machine learning model may trigger the vehicle management system to take action, such as sending a control signal to a piece of hardware. For instance, the vehicle management system may communicate with edge devices located within the managed facility to block off or open portions of the managed facility, display messages at the managed facility, and/or mobilize robotic components of the managed facility. The prediction may trigger the vehicle management system to communicate with a mobile device, such as by sending a notification describing the prediction, contacting employees of the managed facility, and updating the contents of a graphical user interface (GUI).

Additional details about the embodiments are further described below with respect to FIGS. 1-7.

### Configuration Overview

FIG. 1 illustrates one embodiment of a system environment for managing vehicle parking or transit through a managed facility, using an edge device and a vehicle management server. As depicted in FIG. 1, environment 100 includes edge device 110, camera 112, gate 114, data tunnel 116, sensor 118, network 120, a client device 140, and vehicle management server 130. While only one of each feature of environment is depicted, this is for convenience only, and any number of each feature may be present. Where a singular article is used to address these features (e.g., “camera 112”), scenarios where multiples of those features are referenced are within the scope of what is disclosed (e.g., a reference to “camera 112” may mean that multiple cameras are involved).

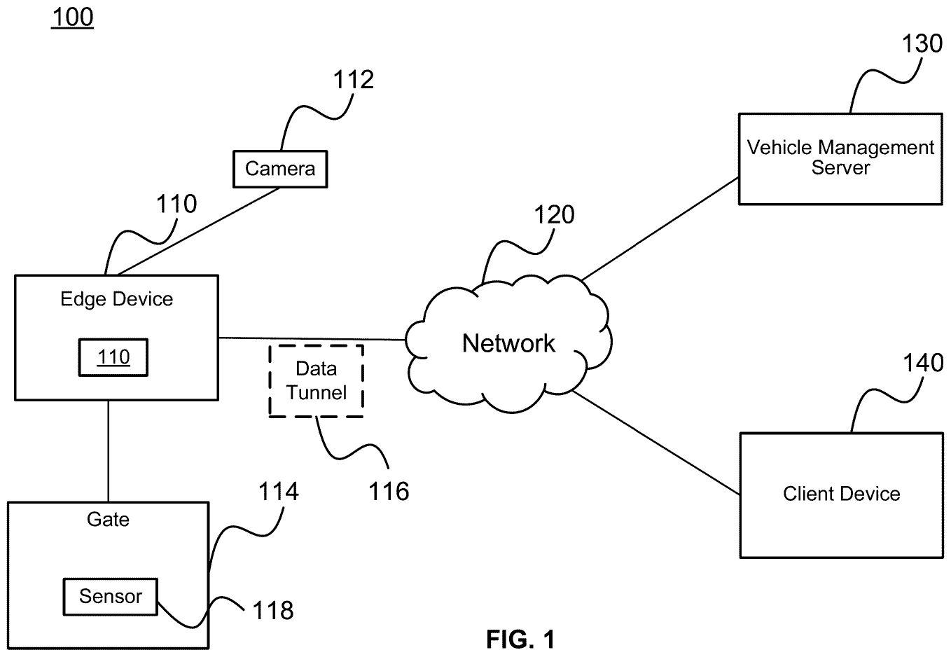

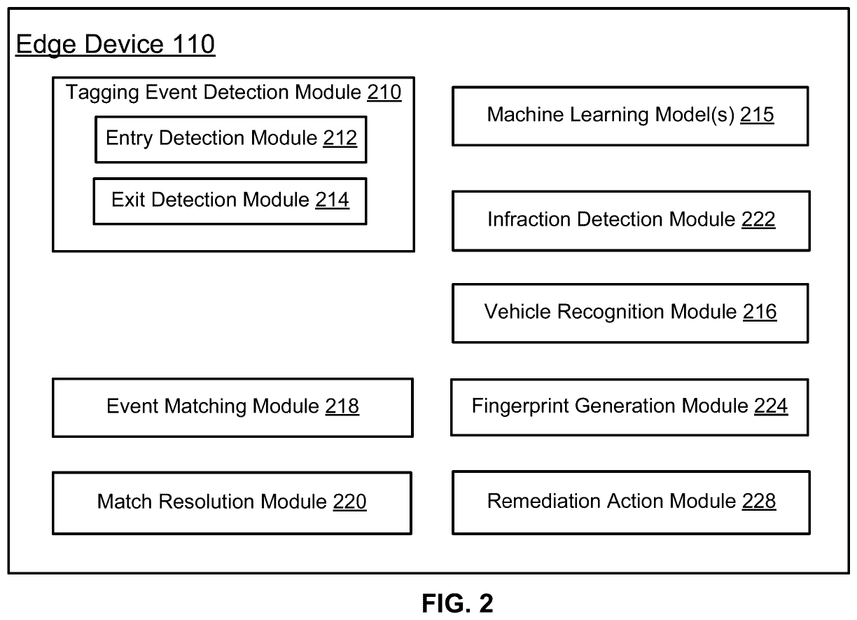

Edge device 110 detects a vehicle approaching gate 114 using camera 112. Edge device 110, upon detecting such a vehicle, performs various operations (e.g., lift the gate; update a profile associated with the vehicle, etc.) that are described in further detail below with reference to at least FIG. 2. Camera 112 may include any number of cameras that capture images and/or video of a vehicle from one or more angles (e.g., from behind a vehicle, from in front of a vehicle, from the sides of a vehicle, etc.). Camera 112 may be in a fixed position or may be movable (e.g., along a track or line) to capture images and/or video from different angles. Where the term image is used, this may be a standalone image or may be a frame of a video. Where the term video is used, this may include a plurality of images (e.g., frames of the video), and the plurality of images may form a sequence that together form the video.

Gate 114 may be any object that blocks entry and/or exit from a facility (e.g., a parking facility) until moved. For example, gate 114 may be a pike that blocks entry or exit by standing parallel to the ground, and lifts perpendicular to the ground to allow a vehicle to pass. As another example, gate 114 may be a pole or a plurality of poles that block vehicle access until lowered to a position that is flush with the ground. Any form of blocking vehicle ingress/egress that is moveable to remove the block is within the context of gate 114. In some embodiments, no physical gate exists that blocks traffic from entering or exiting a facility. Rather, in such embodiments, gate 114 as referred to herein is a logical boundary between the inside and the outside of the facility, and all embodiments disclosed herein that refer to moving the gate equally refer to scenarios where a gate is not moved, but other processing occurs when an entry and exit match (e.g., record that the vehicle has left the facility). Yet further, gate 114 may be any generic gate that is not in direct communication with edge device 110. Edge device 110 may instead be in direct communication with a component that is separate from, but installed in association with, a gate, the component configured by installation to cause the gate to move.

Edge device 110 communicates information associated with a detected vehicle to vehicle management server 130 over network 120, optionally using data tunnel 116. Data tunnel 116 may be any tunneling mechanism, such as virtual private network (VPN). Network 120 may be any mode of communication, including cell tower communication, Internet communication, WiFi, WLAN, and so on. The information provided may include images of the detected vehicle. Additionally or alternatively, the information provided may include information extracted from or otherwise obtained based on the images of the detected vehicle (e.g., as described further below with respect to FIG. 2). Transmitting extracted information rather than the underlying images may result in bandwidth throughput efficiencies that enable real time or near-real-time movement of gate 114 by avoiding a need to transmit high data volume images.

In some embodiments, edge device 110 may apply computer vision to determine environmental factors around the vehicle. The term environmental factors, as used herein, may refer to features that influence traffic flow in the vicinity of gate 114, such as street traffic blocking egress from a facility, orientation of vehicles within images with respect to one another, and so on. In an embodiment, when instructing the moveable gate to move, edge device 110 applies parameters based on the determined environmental factors (e.g., wait to open gate 114 despite matching an exit to an entry due to a vehicle being ahead of the vehicle attempting to exit and therefore blocking egress).

The machine vision may include a license plate detection model. The edge device 110 may apply the license plate detection model to identify license plate numbers on a vehicle when the vehicle enters or exits the managed facility. The identified license plate numbers at the entry event and the exit event may be logged in a database. The entry event and exit event associated with a same license plate number are matched and can be used to determine the vehicle's parking duration in the managed facility or anomalies.

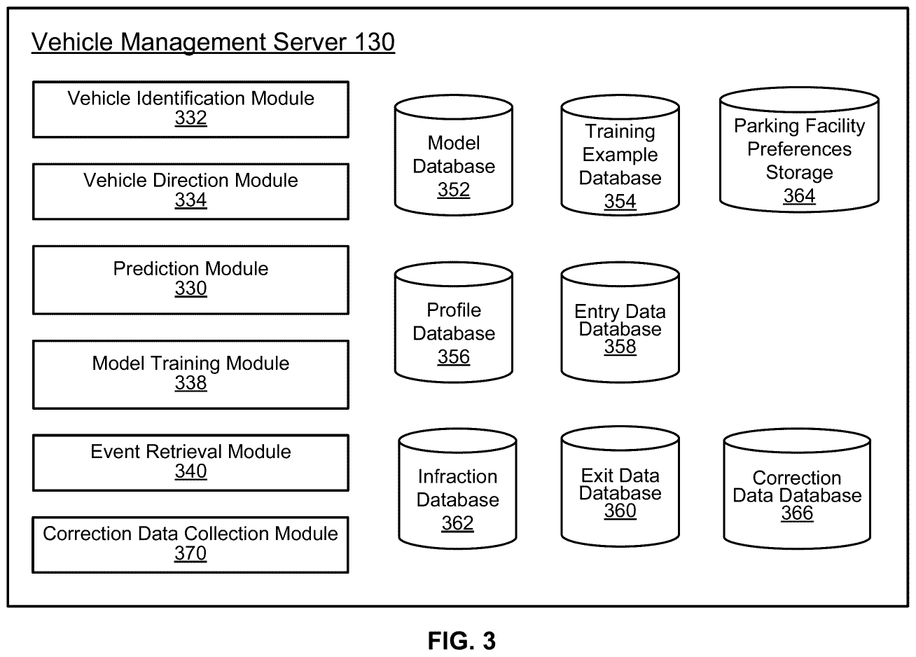

Notably, different cameras are positioned at various locations across managed facilities, each of which may correspond to a different ROI. Accordingly, the vehicle management server 130 may generate a separate mask for each camera based on the images received from that specific camera. The operations of vehicle management server 130 are described in further detail below with reference to at least FIG. 3.

In some embodiments, the vehicle management server 130 may connect with additional edge devices 110 over network 120. Some edge devices 110 may be configured to perform mechanical movements, such as lowering or raising a barrier or moving an object within the managed facility. For example, one such edge device 110 may be an electric vehicle charger that is enabled to charge or not charge vehicles based on control signals send by the vehicle management server 130. Another example is a robot that moves within the facility to direct traffic or assist patrons with moving to/from their vehicles.

FIG. 2 illustrates one embodiment of exemplary modules operated by an edge device. As depicted in FIG. 2, edge device 110 includes a tagging event detection module 210, machine-learning model(s) 215, vehicle recognition module 216, event matching module 218, match resolution module 220, infraction detection module 222, fingerprint generation module 224, and remediation action module 228. The modules depicted with respect to edge device 110 are merely exemplary; fewer or additional modules may be used to achieve the activity disclosed herein. Moreover, the modules of edge device 110 typically reside in edge device 110, but in various embodiments may instead, in part or in whole, reside in vehicle management server 130 (e.g., where images, rather than data from images, are transmitted to vehicle management server 130 for processing). In some embodiments, the modules and functionality of edge device 110 may in whole or in part be implemented in sensor 118.

The tagging event detection module 210 is configured to detect and tag certain events. The events that are being tagged may include entry events, exit events, parking events, and backup events, among others. Entry events include an event when a vehicle enters the managed facility. Exit events include an event when a vehicle exits the managed facility. Some managed facilities include multiple zones, such as a commercial zone and a residential zone. In such a managed facility, an entry event may also be an event when a vehicle enters a zone of the managed facility; an exit event may also be an event when a vehicle exits a zone of the managed facility.

Events related to vehicles in a managed facility may occur in sequences that are logically related. Pairing these events helps facilitate effective management of managed facilities. For instance, an entry of a vehicle into a commercial zone (which may be a general mall parking) followed by its transition to a residential zone represents a pair of events that are logically related. Similarly, a vehicle entering a stadium and subsequently accessing a VIP parking area also represents a pair of events that are logically related.

Considering that entry and exit events are commonly detected, further details about these events are discussed below. Additionally, there are other events related to vehicles that can also be tagged and matched in a sequence between an entry event and an exit event. While the descriptions primarily relate to entry and exit events, the embodiments described herein are also applicable to these other events.

In some embodiments, the tagging event detection module 210 includes an entry detection module 212 configured to detect entry events and an exit detection module 214 configured to detect exit events. Entry detection module 212 detects and stores an entry event. An entry event represents a vehicle approaching a managed facility from an entry side and entering the managed facility or a zone of the managed facility, in some embodiments through an entry gate. Entry detection module 212 may detect the entry event by using camera 112 to capture a series of images over time. Camera 112 may continuously capture images or may capture images when certain conditions are met (e.g., motion is detected, or any other heuristic such as during certain times of day). In an embodiment, edge device 110 may continuously receive images from camera 112 and may determine whether the images include a vehicle, in which case entry detection module 212 may perform processing on images that include a vehicle and discard other images. In an embodiment, entry detection module 212 may command camera 112 to only transmit images that include vehicles and may perform processing on those images. The captured images are in association with a moveable gate or logical boundary (e.g., gate 114), in that each camera 112 is either facing a gate or an area in a vicinity of a gate (e.g., just the entry side, just the exit side, or both). Each image may have a timestamp and/or a sequence number. Entry detection module 212 may associate all images that include a motion of a given vehicle from a time the vehicle enters the images until the time that the vehicle exits the images (e.g., during the time that the vehicle approaches the gate and then drives through or past the gate). In some embodiments, entry detection module 212 may, for images that include motion of the given vehicle, isolate portions of the images that contain the vehicle and exclude portions of the images that do not contain the vehicle (e.g., background, environment, other vehicles). For example, entry detection module 212 may put a bounding polygon on a portion of an image that contains the largest vehicle in the frame. From images that contain the vehicle, entry detection module 212 may further isolate or put bounding polygons around a portion of the image that contains a vehicle identifier, such as a license plate.

Entry detection module 212 may determine, from images featuring the vehicle, a data set corresponding to the vehicle. The data set may include parameters that describe attributes of the vehicle and a vehicle identifier. Parameters describing attributes of the vehicle may include both identifying attributes and direction attributes of the vehicle. Identifying attributes may include any information that is derivable from the images that describe the vehicle, such as make, model, color, type (e.g., sedan versus sports utility vehicle), height, length, bumper style, number of windows, door handle type, and any other descriptive features of the vehicle. Direction attributes may refer to absolute direction (e.g., cardinal direction) or relative direction (e.g., direction of the vehicle relative to an entry gate and/or relative to an assigned direction of a lane which the entry gate blocks (e.g., where different gates are used for entry and exit lanes, and where a vehicle is approaching a gate from an entrance to a managed facility through an exit lane, the direction would be indicated as opposite to an intended direction of the lane)). Direction attributes may also be determined relative to a camera's imaging access and are thus indicative of whether the vehicle is moving toward or away from the camera.

The machine-learning model(s) 215 are used to process the images associated with the entry event and exit event. In some embodiments, the entry detection module 212 and the exit detection model 214 apply the machine-learning model(s) 215 to the captured images to determine identifications of the vehicles.

In an embodiment, a single machine-learning model is used to produce the entire data set, both the parameters and the vehicle identifier. In another embodiment, a first machine-learning model is used to determine the parameters and a different second machine-learning model is used to determine the vehicle identifier.

In the two-model approach, entry detection module 212 determines the parameters by inputting images featuring the vehicle into a first machine-learning model, and receiving, as output from the first machine-learning model, the parameters describing attributes of the vehicle. In an embodiment, the output of the first machine-learning model may be more granular, and may include a number of objects in an image (e.g., how many vehicles), types of objects in the image (e.g., vehicle type information, or per-vehicle identifying attribute information), result scores (e.g., confidence in each object classification), and bounding boxes (e.g., of sub-segments of the image for downstream processing, such as of a license plate for use by the second machine-learning model).

The first machine-learning model may be trained to output identifying attributes using example data having images of vehicles that are labeled with one or more candidate identifying attributes. For example, various images from cameras facing gates may be manually labeled by users to indicate the above-mentioned attributes, such as, for each of the various images, a make, model, color, type, and so on of a vehicle. The first machine-learning model may be a supervised model that is trained using the example data to predict, for new images, their attributes.

The first machine-learning model may be trained to output direction attributes of the vehicle using example data, and/or to output data from which entry detection module 212 may determine some or all of the direction attributes. The example data may show motion of vehicles relative to one or more gates over a series of sequential frames, and may be annotated with a lane type (e.g., an entry lane versus an exit lane) and/or a gate type (e.g., exit gate versus entry gate), and may be labeled with a direction between two or more frames (e.g., toward an entry gate, away from an entry gate, toward an exit gate, away from an exit gate). Lane type may be derived by environmental factors (e.g., a model may be trained to recognize through enough example data that a direction past a gate that shows blue sky is an exit direction, and toward a halogen light is an entry direction). From this training, the first machine-learning model may output direction directly based on learned motions relative to gate type and/or lane type, or may output lane type and/or gate type as well as indicia of directional movement, from which entry detection module 212 may apply heuristics to determine the direction attributes (e.g., toward entry gate, away from entry gate, toward exit gate, away from exit gate). That is, a direction vector along with a gate type and/or lane type may be output (e.g., environmental factors may be output along with the direction vector, which may include other information such as lighting, sky information, and so on), and the direction vector along with the environmental factors may be used to determine the direction attribute.

It is advantageous to determine direction attributes along with identifying attributes, as vehicles are being tracked as they move. However, determining direction attributes and identifying attributes in one step may result in false positives. With that being said, a separate model could be used for identifying attribute detection and for direction attribute detection, thus resulting in a three-model approach (two models being used for what above is referenced to as a “first machine-learning model”, each of those separate models trained separately using respective training data for each respective task.

Continuing with the two-model approach, entry detection module 212 determines the vehicle identifier by inputting images featuring a depiction of a license plate of the vehicle into a second machine-learning model. That is, rather than using optical character recognition (OCR), the second machine-learning model may be used to decipher a license plate of the vehicle into a vehicle identifier of the vehicle. OCR methods are often inaccurate for license plate detection due to complexity of license plates, where different fonts (e.g., cursive versus script) are used, often against complex picture-filled backgrounds, different colors, and lighting issues. Moreover, various license plate types are difficult to accurately read because they often include slogans that are not generalizable. Even minor accuracies in OCR readings where one character or a geographical identifier determination is off could cause could result in an inability to effectively identify a vehicle.

To this end, the second machine-learning model may be trained to identify and output both a geographical nomenclature and a string of characters of a vehicle identifier (e.g., either directly, or with a confidence score that exceeds a threshold applied by entry detection module 212). As used herein, the term “geographical nomenclature” may refer to a manner of identifying a jurisdiction that issued the license plate. That is, in the United States of America, an individual state would issue a license plate, and the geographical identifier would identify that state. In some jurisdictions, a country-wide license plate is issued, in which case the geographical identifier is an identifier of the country. A geographical identifier may identify more than one jurisdiction (e.g., in the European Union (EU), some license plates identify both the EU and the member nation that issued the license plate; the geographical identifier may identify both of those places or just the member nation). The term “string of characters” may refer to a unique symbol issued by the jurisdiction to uniquely identify the vehicle, such as a “license plate number” (which may include numbers, letters, and symbols). That is, for each given jurisdiction, the string of characters is unique relative to other strings of characters issued by that given jurisdiction. In some embodiments, a license plate number for a vehicle may include a string of characters where the characters are both vertically written (e.g., read from top to bottom) and horizontally written (e.g., read from left to right). The term “license plate identifier” may refer to the combination of the geographical nomenclature and the license plate number.

To train the second machine-learning model, training examples of images of license plates are used, where the training examples are labeled. In an embodiment, the training examples are labeled with both the geographical jurisdiction and with characters that are depicted within the image. The characters may be individually labeled (e.g., by labeling segments of the image that include the segment), the whole image may be labeled with each character that is present, or a combination thereof. For strings of characters including both vertically and horizontally written characters, the string may be labelled in a standardized format, such as with a left to right, top to bottom rule (e.g., a license plate

$$\begin{matrix}A \\ B\end{matrix} 12345$$

may be labelled as AB12345, and a license plate

$$6 \begin{matrix}C \\ D\end{matrix} 7890$$

may be written as 6CD7890). In some embodiments, training examples may only be labeled by whether they include both vertically and horizontally written characters, and the second machine-learning model predicts for a new image of a license plate whether the license plate number includes both vertically and horizontally written characters. Following this prediction, entry detection module 212 may apply a third machine-learning model to license plates with vertically and horizontally written characters, the third machine-learning model trained specifically to predict the license plate numbers for license plates with both vertically and horizontally written characters.

In an embodiment, the training examples may be labeled only with the geographical jurisdiction, and the second machine-learning model predicts for a new image of a license plate the geographical jurisdiction. Following this prediction, a third machine-learning model from a plurality of candidate machine-learning models may be selected, each of the candidate machine-learning models corresponding to a different geographical jurisdiction and trained to predict characters of the string of characters from training examples specific to its respective geographical jurisdiction, the selected third machine-learning model selected based on the predicted geographical jurisdiction. The third machine-learning model may be applied to the image or segments thereof that contain each character, thus resulting in a prediction from training examples specific to that jurisdiction.

In any case, the training examples may show examples in any number of conditions, from low lighting conditions, dirty license plate conditions where characters are partially or fully occluded, license plate frame conditions where geographical identifiers (e.g., the word “New York”) are partially or fully occluded, license plate covers render characters hard to directly read, and so on. Advantageously, by using machine learning to predict geographical nomenclature and strings of characters, accuracy is improved relative to OCR, as even where partial occlusion occurs or lighting conditions make characters difficult to read, the second machine-learning model is able to accurately predict the content of the license plate.

In a one-model approach, the manners of training the first and second machine-learning model would be applied to a single model, rather than differentiating what is learned between the two models. This would result in an advantage of providing all inputs as one data set to a model, but could also result in a disadvantage of a less specialized model that has noisier output. Moreover, data and time intensive to train one large model to perform all of this functionality. The large model may be slower and have a lower quality of output than using two separate models. The two-model approach additionally allows for a “fail fast” processing to happen—that is, detect a vehicle and perform processing based on that detection, even before other activity (e.g., license plate reading) is completed.

Regardless of what model approach is used, in an embodiment, entry detection module 212 may determine, from direction attributes of the vehicle, whether the direction attributes of the vehicle are consistent with the function of the entry gate, thus confirming that the vehicle performed an entry event. Namely, the entry detection module 212 determines that the vehicle used or is using the entry lane as opposed to the exit lane. In some embodiments, the entry detection module 212 may move the gate to enable entry to the facility that is blocked by the gate (or where the gate is a logical boundary, record that the vehicle has entered the facility without a need to move the gate).

In some embodiments, entry detection module 212 may determine a feature vector corresponding to the entry event, an “entry feature vector.” To produce the entry feature vector, the entry detection module 212 inputs a depiction of the vehicle into a supervised machine-learning model. The depiction of the vehicle may include the images that include the vehicle, for example as captured by camera 112. In some embodiments, the depiction of the vehicle may include only the isolated portions of the images that contain the vehicle. In some embodiments, the depiction of the vehicle may include other data, such as data from the data set. The supervised machine-learning model outputs the entry feature vector. The entry feature vector may include a plurality of embeddings, where each embedding is derived from one or more dimensions of the depiction of the vehicle. The supervised machine-learning model may be trained to output a feature vector. In some embodiments, the supervised machine-learning model may be trained such that feature vectors corresponding to different vehicles have a maximum amount of distance from each other in the feature space. For example, the supervised machine-learning model may be trained such that a feature vector is penalized based on angular margins between the feature vector and other feature vectors, where the smaller the angular margins, the greater the penalties. This training results in a greater distance between feature vectors.

In some embodiments, the supervised machine-learning model may be a multi-task model, such as a multi-task neural network with branches that are each trained to determine different parameters. The structure of the multi-task model has a set of shared layers and a plurality of branching task-specific layers, each branch of the branching task-specific layers corresponding to a task. The tasks are related within the domain, meaning that each of the tasks determines parameters that are determinable based on a highly overlapping information space. For example, in determining the entry feature vector for the vehicle, the different tasks may predict the license plate of the vehicle, the make and model of the vehicle, and so on. As such, when trained, the shared layers produce information that is useful for performing each of tasks and outputting each of these predictions. Embeddings of the one or more of the shared layers may be used to produce a feature vector.

While the model that entry detection module 212 uses to produce the entry feature vector is described as a supervised machine-learning model, a supervised machine-learning model is merely exemplary. Entry detection module 212 may use other types of models to generate entry feature vectors. For example, entry detection module 212 may use a classification model (e.g., a logistic regression, decision tree, random forest, or naive bayes model) to classify the vehicle in the entry event.

As described later with respect to event matching module 218 and match resolution module 220, the process to match an entry event and an exit event (e.g., a representation of a vehicle exiting the managed facility) may not always require the entry detection module 212 to generate a feature vector. Event matching module 218 may match entry and exit events without using feature vectors. For example, if the vehicle is a known vehicle, event matching module 218 may match an entry event to an exit event based on the vehicle's vehicle identifier alone. Or, in another example, event matching module 218 may match entry events to exit events based on the data set of the entry and exit events, for example matching based on type, model, and color of vehicle. However, responsive to event matching module 218 not finding a match between an entry and exit event, match resolution module 220 may attempt to match entry and exit events using feature vectors. Match resolution module 220 may request feature vectors from entry detection module 212. As such, in some embodiments, to avoid generating feature vectors when they may not necessarily be used in the matching process, entry detection module 212 may hold off on generating a feature vector responsive to detecting entry of a vehicle and instead produce an entry feature vector responsive to receiving a request from match resolution module 220. This approach saves on computer resources (e.g., processing power, memory) by first attempting less computationally expensive means to match entry and exit events before producing feature vectors.

Entry detection module 212 may store the entry event corresponding to the vehicle in entry data database 358 of the vehicle management server 130. The entry event corresponding to the vehicle includes the data set corresponding to the vehicle (e.g., the parameters and the vehicle identifier) and, in some embodiments, the entry feature vector, images featuring the vehicle, timestamps corresponding to the entry (e.g., time stamps and/or sequence numbers of the images), and the managed facility the vehicle entered. In an embodiment, the entry detection module 212 may store the entry event at edge device 110.

Exit detection module 214 operates in a manner similar to entry detection module 212, in that machine learning is applied in in a similar manner in order to detect an exit event. That is, a data set and/or feature vector identical to that determined when a vehicle performs an entry motion is performed for an exit motion, where it is detected that a vehicle is approaching gate 114 to exit a facility or a zone of the facility. When an exit motion is detected (e.g., where a vehicle is determined to have directional attributes consistent with approaching a gate designated for use as an exit), exit detection module 214 determines that an exit event may have occurred (e.g., and other activity such as generation and storage (e.g., in exit data database 360) of a data structure or a feature vector as described with respect to entry events may be performed). In some embodiments, exit detection module 214 may determine the feature vector in response to the edge device 110 determining that an exit event does not match an entry event.

Vehicle recognition module 216 determines if a vehicle is a known vehicle. A known vehicle is a vehicle with a profile stored in profile database 356. Vehicle recognition module 216 may retrieve the vehicle identifier (e.g., license plate) from the entry event associated with the vehicle (e.g., stored in entry data database 358). Vehicle recognition module 216 may search the profile database 356 using the vehicle identifier as an index. Responsive to finding an entry in profile database 356 that corresponds to the vehicle identifier, vehicle recognition module 216 determines that the vehicle is known. Vehicle recognition module 216 may determine if a vehicle is a known vehicle responsive to a vehicle entering or exiting the managed facility and as such may update the respective entry data database 358 or exit data database 360 with the vehicle identifier or with an indication that the vehicle is known and has a profile in profile database 356.

Event matching module 218, responsive to exit detection module 214 detecting an exit event, determines whether a match exists between the detected exit event and an entry event. Namely, event matching module 218 determines if a vehicle corresponding to an entry event is the same as the vehicle corresponding to the exit event. In some embodiments, the event matching process may be as simple as determining whether the vehicle corresponding to the exit event is known and matching the exit event to an entry event corresponding to the known vehicle. Event matching module 218 determines whether the vehicle corresponding to the exit event is known by using vehicle recognition module 216, which relies on the vehicle identifier (e.g., license plate) to search profile database 356 for a profile of the vehicle. Responsive to determining that the vehicle corresponding to the exit event is a known vehicle, event matching module 218 may search either entry data database 358 or profile database 356 with the vehicle identifier to determine if there exists a record of the known vehicle entering the managed facility. Responsive to finding an entry event for the known vehicle, event matching module 218 matches the exit event with the entry event.

However, license plate reading, even using the described second machine-learning model, is not perfect. Factors such as low image quality, low frame rate, lighting conditions (e.g., glare, low lighting), debris, dirt, or weather-related conditions (e.g., snow, ice, rain, mud) may obscure license plate information and make license plates difficult to read. As such, vehicle recognition module 216 may be unable to determine whether the vehicle is known based on the vehicle identifier, and as a result the event matching module 218 may not be able to match the exit event to the entry event using the vehicle identifier alone.

In some embodiments, event matching module 218 matches the exit event to an entry event by comparing information in the data set of the exit event to information in the data set of an entry event of a set of entry events. Event matching module 218 determines a match between the exit event and an entry event of the set of entry events where heuristics are satisfied. For example, event matching module 218 may determine that the exit event matches an entry event if the license plate number and geographical nomenclature match. Because license plate numbers are not unique identifiers and can be duplicated so long as the geographical nomenclature is unique, if the exit event and an entry event match between license plate numbers but not between geographical nomenclatures, event matching module 218 would not match the exit event with the entry event. As previously described, because license plate reading is not perfect, it may be the case that a match is not found by event matching module 218 using the vehicle identifier alone. To this end, a match may be determined based on other identifying information from the data sets of the exit and entry events, such as identifying a partial match of a geographical nomenclature and/or other vehicle attributes that match such as make, model, color, and so on. Any heuristics may be programmed to determine whether or not a match has occurred.

Event matching module 218 may filter the entry events to compare the exit event to. For example, event matching module 218 may compare the exit event only to unmatched entry events, to entry events associated with the same managed facility, or to entry events with timestamps within a threshold time window (e.g., within a 24-hour time window). Event matching module 218 may filter entry events such that the set of entry events includes events associated with vehicles of the same type (e.g., car or truck), color, or model as the vehicle associated with the entry event.

Responsive to detecting a match, event matching module 218 may instruct vehicle management server 130 to indicate in profile database 356, entry data database 358, or the exit data database 360 that the vehicle has exited the facility. For example, event matching module 218 may instruct vehicle management server 130 to delete the entry event and exit event of the vehicle or to archive them in a separate database. In some embodiments, responsive to detecting a match, event matching module 218 may raise gate 114 (e.g., where gate 114 is a physical gate rather than a logical boundary), thus allowing the vehicle to exit the facility.

Responsive to not detecting a match, event matching module 218 may expand the set of entry events that the exit event could be matched to and retry the matching process. For example, event matching module 218 may expand the set of entry events to include entry events associated with managed facilities beyond the managed facility associated with the exit event, such as managed facilities within a threshold distance from the managed facility associated with the exit event. In another example, event matching module 218 may expand the time window the entry events are associated with, for example to include entry events that took place within a month instead of within a day.

In some embodiments, responsive to not detecting a match between the exit event and an entry event, event matching module 218 may refer to match resolution module 220.

Match resolution module 220 resolves matches between exit events and hanging entry events. A hanging entry event is an entry event for a vehicle where entry detection module 212 was unable to identify a vehicle identifier. Match resolution module 220 may determine (e.g., by exit detection module 214) or retrieve (e.g., from exit data database 360) an exit feature vector corresponding to the exit event. Match resolution module 220 may determine (e.g., by entry detection module 212) or retrieve (e.g., from entry data database 358) a set of entry feature vectors corresponding to a set of hanging entry events. Match resolution module 220 may input the exit feature vector and the set of entry feature vectors into an unsupervised machine-learning model.

The unsupervised machine-learning model may output a matching score for each entry feature vector. The matching score may represent how well the entry event matches with the exit event such that better matches have higher matching scores. In these embodiments, match resolution module 220 may match the exit event with an entry event based on the matching scores. For example, match resolution module 220 may automatically match the exit event with the entry event that has the highest matching score. In other embodiments, match resolution module 220 may compare the match scores to a threshold score. Responsive to the highest match score exceeding the threshold score, match resolution module 220 may determine the entry event with the highest match score to be a match with the exit event. Responsive to the match scores not exceeding the threshold score, match resolution module 220 may determine that there is no match for the exit event. In some embodiments, match resolution module 220 may compare the difference between the two highest two match scores to a threshold difference and, only in response to the difference exceeding the threshold difference, match the exit event with the entry event with the highest match score. Thus, if the top two entry events are similarly well-matched to the exit event (e.g., with match scores within the threshold difference from one another), match resolution module 220 may determine that there is no match for the exit event. In other embodiments, the match resolution module 220 may provide, for display, a subset of entry events for an administrator to manually select a match for the exit event.

In some embodiments, match resolution module 220 may resolve hanging entry events without waiting for a matching exit event. To do so, match resolution module 220 may match a hanging entry event to a previous entry event, where the previous entry event corresponds to a known vehicle. Match resolution module 220 may determine or retrieve an entry feature vector corresponding to the hanging entry event and determine or retrieve (e.g., from entry data database 358) a set of entry feature vectors corresponding to previous entry events. Match resolution module 220 may input the entry feature vector corresponding to the hanging entry event and the set of entry feature vectors corresponding to previous entry events into an unsupervised machine-learning model. The unsupervised machine-learning model may output a matching score for each entry feature vector that corresponds to a previous entry event.

While the model that match resolution module 220 uses to resolve matches between exit events and hanging entry events is described as an unsupervised machine-learning model, an unsupervised machine-learning model is merely exemplary. Match resolution module 220 may use other types of models to generate entry feature vectors. For example, match resolution module 220 may use a mathematical model that uses cosine similarity to compute the similarity between exit and entry feature vectors.

Match resolution module 220 may select the set of previous entry events. Match resolution module 220 may select entry events that the entry detection module 212 detected within a window of time, such as a window of the last three days. Match resolution module 220 may select entry events that occurred at the same managed facility as the hanging entry event. Match resolution module 220 may select entry events with vehicles of the same type (e.g., truck, SUV, sedan), model, or color as the vehicle corresponding to the hanging entry event. In some embodiments, match resolution module 220 may start by selecting a smaller set of previous entry events where a match may be more likely (e.g., entry events that occurred at the same managed facility in the last 3 days), and, responsive to not resolving a match between the hanging entry event and the selected set of previous entry events, iteratively select larger and larger sets of previous entries with which to retry the matching process (e.g., entry events that occurred within the last month at managed facilities within 20 miles of the managed facility associated with the hanging entry event). Match resolution module 220 may use metrics like retention to further inform selection of the set of previous entry events. For example, if retention (e.g., the rate of vehicles returning to the same managed facility) is 80% in one month, match resolution module 220 may select the set of previous entry events to be entry events that occurred at the same managed facility within one month. However, if retention is 30% in one month, match resolution module 220 may select the set of previous events to be entry events that occurred at a group of managed facilities (e.g., within the same zip code, within a threshold distance) instead of the same managed facility within one month. By using an iterative search process to check sets of previous events where a match is more likely before expanding to check larger sets of previous events, match resolution module 220 may save on time as well as computational resources (e.g., processing power, storage, etc.).

Responsive to the event matching module 218 or match resolution module 220 matching the exit event with an entry event, in some embodiments, edge device 110 may update profile database 356 of the vehicle management server with any or all events, data sets or feature vectors that describe the vehicle. If the vehicle does not have a profile in profile database 356, edge device 110 may request for vehicle management server 130 to create a profile for the vehicle. If the vehicle does have an existing profile in profile database 356, edge device 110 may request for vehicle management server 130 to update the profile with new information corresponding to the vehicle (events, data sets, feature vectors). In some embodiments, edge device 110 may update the entry data database 358 and the exit data database 360 to reflect the match between an exit event and an entry event (e.g., removing entries or indicating that the event is matched).

Responsive to the event matching module 218 or match resolution module 220 not detecting a match, edge device 110 or vehicle management server 130 may provide a message for display to the user of the vehicle corresponding to the exit event. The message may include an indication that the user's vehicle was unable to be matched and/or a request for the user to manually enter vehicle information (e.g., license plate information) or create a profile. The managed facility may display the message on a screen, for example a screen located at the exit gate.

Notably, when the match resolution module 220 matches a hanging entry event and a hanging exit event, a license plate identification associated with at least one of these events is corrected. The corrected data can be gathered to create new training examples, which can then be used to retrain the machine-learning models for vehicle identification. In some embodiments, each recognized license plate is assigned to a confidence score that indicates a probability of its accurate identification. The matched hanging entry event and hanging exit event are each associated with a confidence score. In some embodiments, the license plate identification from the event with the higher confidence score is used for both events in the pair. As such, the event with the lower confidence score is subsequently updated to share the same license plate identification as its matched counterpart, which can then be used to generate a new training example.

Infraction detection module 222 detects infractions caused by vehicles and triggers remediation actions responsive to detecting entry of those vehicles. An infraction may be a violation of rules associated with the managed facility. A set of non-exhaustive examples of infractions may include damaging gates of the managed facility (e.g., bumping into or crashing through entry or exit gates), damaging other vehicles in the managed facility, entering the managed facility with no profile associated with the vehicle, speeding within the managed facility, taking up more than one parking space, parking outside of a parking space, or staying within the managed facility during restricted hours (e.g., overnight, past closing time, for too long a time period). In some embodiments, infraction detection module 222 may detect infractions caused by users of the managed facility, both users associated with vehicles and users not associated with vehicles. Infractions caused by users may, for example, include damaging, breaking into, or stealing vehicles.

Infraction detection module 222 may detect an infraction based on sensor data. Sensor data may include data from camera 112, sensor 118 attached to gate 114, a parking sensor, an audio sensor, a speedometer, or from any other type of sensor in the managed facility. A parking sensor detects when a vehicle is in a parking space. Example parking sensors include magnetometers, ultrasonic sensors, or optical sensors. Infraction detection module 222 may use different sensors for different types of infractions. For example, infraction detection module 222 may use sensor 118 to detect if a gate has moved from one of the operating states (e.g., open, closed) to a state of being ajar, which may indicate that a vehicle bumped into the gate. In another example, infraction detection module 222 may use an audio sensor to detect when a vehicle is broken into (e.g., by detecting the sound of glass shattering or a car alarm).

In some embodiments, infraction detection module 222 may use multiple sensors in combination to detect the infraction. For example, infraction detection module 222 may use camera 112 and a combination of parking sensors to determine if a vehicle is in more than one parking space. Responsive to two or more parking sensors for two or more adjacent parking spaces detecting that the parking spaces have transitioned from a vacant state (e.g., no vehicle detected) to an occupied state (e.g., vehicle detected) within a threshold amount of time, infraction detection module 222 may detect an infraction. Infraction detection module 222 may use camera 112 data to confirm whether the instance of two parking sensors for adjacent parking spots detecting vehicles at the same time included the parking sensors detecting two or more separate vehicles that happened to pull in at the same time or detecting one vehicle taking up multiple parking spaces. In another example, infraction detection module 222 may use an audio sensor to detect the sounds of shattering glass and a car alarm and use camera 112 to confirm an infraction involving a user breaking into a vehicle.

In some embodiments, infraction detection module may use a moveable camera system. A set of non-exhaustive examples of moveable camera systems include a camera on wheels (e.g., on a vehicle), a camera configured to move along a wire or beam running across a ceiling, and/or a drone camera. Infraction detection module 222 may command the moveable camera system to navigate to the location of the infraction. For example, infraction detection module 222 may command the moveable camera system to navigate to a vantage point comprising the aforementioned adjacent parking spaces, capture images of the adjacent parking spaces, and determine whether the vehicle is occupying the adjacent parking spaces. In some embodiments, infraction detection module 222 may command the moveable camera system to navigate to the location of the infraction responsive to sensor data from another sensor (e.g., parking sensor) detecting the infraction. In some embodiments, infraction detection module 222 may command the moveable camera system to periodically move through the managed facility, scanning for infractions. For detecting infractions, a moveable camera system may be more efficient than a system with many stationary cameras as it reduces resources required to install cameras throughout a managed facility and maintain the cameras (e.g., power the cameras while the managed facility is open). Moreover, by triggering navigation of the moveable camera system responsive to detection of certain sensor data, fuel, energy, and processing of images from the moveable camera system is minimized to only scenarios where the possibility of an infraction is first detected, thereby improving efficiency.

In some embodiments, infraction detection module 222 may log the infraction in infraction database 362 along with other information associated with the infraction (e.g., timestamp).

Fingerprint generation module 224 generates a vehicle fingerprint in response to the detection of an infraction. A vehicle fingerprint for an infracting vehicle may include a feature vector corresponding to the vehicle, an “infraction feature vector.” The fingerprint may include other information associated with the vehicle, for example a vehicle identifier or various vehicle parameters. Fingerprint generation module 224 generates the vehicle fingerprint by inputting a depiction of the vehicle into a model (e.g., a supervised machine-learning model). The depiction of the vehicle may include the images that include the vehicle, for example as captured by camera 112. The model may be similar to the supervised machine-learning model or other models described with respect to entry detection module 212 and thus may be trained as discussed with respect to entry detection module 212. Fingerprint generation module 224 receives, as output from the model, an infraction feature vector describing the vehicle involved in the detected infraction. The infraction feature vector may include a plurality of embeddings, where each embedding is derived from one or more dimensions of the depiction of the vehicle. In some embodiments, fingerprint generation module 224 adds the infraction feature vector to an infraction database, such as infraction database 362. In some embodiments, fingerprint generation module 224 generates a vehicle fingerprint without the detection of an infraction.

In embodiments where infraction detection module 222 detects an infraction caused by a user, fingerprint generation module 224 may determine a vehicle associated with the user and generate a vehicle fingerprint for the user's vehicle. To do so, fingerprint generation module 224 may retrieve a timestamp of the infraction from infraction database 362. Fingerprint generation module 224 may access sensor data (e.g., RFID reader on a locked pedestrian door to the managed facility, camera 112) within a threshold time window around the timestamp of the infraction. Using the sensors, fingerprint generation module 224 may determine how the user entered the managed facility. Responsive to determining that the user entered through an RFID-enabled pedestrian door to the managed facility, fingerprint generation module 224 may access logs associated with the pedestrian door and access a set of user credentials through which the user gained entry into the managed facility. User credentials may include user information, such as user profile information, through which fingerprint generation module 224 may obtain the vehicle identifier associated with the user. Responsive to determining that the user entered the managed facility in a vehicle, fingerprint generation module 224 may obtain the vehicle information stored in the entry log associated with the vehicle.

In some embodiments, fingerprint generation module 224 determines whether the vehicle is unknown and generates a vehicle fingerprint in response to the vehicle being unknown. The vehicle may be determined by fingerprint generation module 224 to be unknown responsive to determining that the vehicle does not exist in profile database 356 or if the vehicle identifier (e.g., geographical nomenclature and license plate number) for the vehicle is not recognized. To determine if the vehicle is unknown, fingerprint generation module 224 may extract the vehicle identifier from the vehicle using a model similar to the supervised machine-learning model described with respect to entry detection module 212. Fingerprint generation module 224 may search the profile database 356 using the vehicle identifier as an index. Responsive to determining that the vehicle is known, fingerprint generation module 224 may use an existing feature vector of the vehicle (e.g., an entry or exit feature vector stored in profile database 356) as the infraction feature vector of the vehicle fingerprint.

Entry detection module 212 monitors for the entry of vehicles associated with infractions to any of a plurality of managed facilities. At each managed facility, entry detection module 212 may receive, from entry detection module 212, a data set and/or entry feature vector corresponding to a vehicle entering the managed facility. Entry detection module 212 may compare the entry feature vector of the vehicle to vehicle fingerprints stored in the infraction database. In some embodiments, entry detection module 212 may input the entry feature vector and a set of infraction feature vectors (e.g., from vehicle fingerprints) into a model and receive, as output from the model, a match score for each infraction feature vector. The model may be similar to the unsupervised machine-learning model of match resolution module 220. The entry detection module 212, similarly to match resolution module 220, may match the entry feature vector to an infraction feature vector of the set of infraction feature vectors based on the matching scores.

Remediation action module 228 triggers a remediation action responsive to entry detection module 212 detecting the entry of a vehicle associated with an infraction. Example remediation actions include issuing an infraction (e.g., parking ticket or other citation), contacting an administrator of the managed facility, contacting an external authority (e.g., law enforcement), deploying an exit or entry blocking device that prevents movement of the vehicle within the managed facility (e.g., metal bars, tire shredder, closing or not opening the gate), displaying a message to a user associated with the vehicle, or otherwise requesting an action from the user (e.g. email, text, or push notification).

In some embodiments, remediation action module 228 trigger different remediation actions for different types of infractions. As such, remediation action module 228 may determine the type of infraction and transmit a remediation command resulting in the remediation action based on the infraction type. For example, for the infraction of entering the managed facility with no profile associated with the vehicle, the remediation action module 228 may trigger an action prompting a user of the vehicle to enter profile details (e.g., contact information, license plate number). In another example, for the infraction of taking up multiple parking spaces, remediation action module 228 may trigger a remediation action that allocates for the use of the multiple parking spaces. For the infraction of damaging a gate, remediation action module 228 may trigger a remediation action of contacting an administrator of the managed facility. In some embodiments, remediation action module 228 may trigger different remediation actions depending on the managed facility. Remediation action module 228 may store remediation action preferences for different managed facilities, for example in managed facility preferences storage 364 of vehicle management server 130. In some embodiments, remediation action module 228 may trigger multiple remediation actions. For example, remediation action module 228 may trigger two remediation actions at once. Additionally or alternatively, remediation action module 228 may trigger a first a remediation action and wait a threshold window of time before cancelling or triggering a second remediation action. For example, remediation action module may issue a message to a user and wait ten minutes before contacting law enforcement. Responsive to the user resolving the issue within the threshold time window, remediation action module 228 may cancel the second remediation action. Responsive to the user not resolving the issue within the threshold time window, remediation action module 228 may trigger the second remediation action.

Remediation action module 228 may remove the vehicle from the infraction database. Remediation action module 228 may remove the vehicle from the infraction database in response to a request from an administrator of a managed facility or in response to the user of the vehicle performing a remediation response corresponding to the remediation action (e.g., creating a profile, addressing a citation, etc.).

FIG. 3 illustrates one embodiment of exemplary modules operated by a vehicle management server. As depicted in FIG. 3, vehicle management server 130 includes vehicle identification module 332, vehicle direction module 334, prediction module 330, model training module 338, event retrieval module 340, model database 352, profile database 356, training example database 354, entry data database 358, exit data database 360, infraction database 362, managed facility preferences storage 364, correction data collection module 370, and correction data database 366. The modules and databases depicted in FIG. 3 are merely exemplary, and fewer or more modules and/or databases may be used to achieve the activity that is disclosed herein. Moreover, the modules and databases, though depicted in vehicle management server 130, may be distributed, in whole or in part, to edge device 110, which may perform, in whole or in part, any activity described with respect to vehicle management server 130. Yet further, the modules and databases may be maintained separate from any entity depicted in FIG. 1 (e.g., license plate training module 338 may be housed entirely offline or in a separate entity from vehicle management server 130).

Vehicle identification module 332 identifies a vehicle using the first machine-learning model described with respect to entry detection module 212. In particular, vehicle identification module 332 accesses the first machine-learning model from model database 352, and applies input images and/or any other data to the machine-learning model, receiving parameters of the vehicle therefrom. Vehicle identification module 332 acts in the scenario where images are transmitted to vehicle management server 130 for processing, rather than being processed by edge device 110. Similarly, vehicle direction module 334 determines a direction of a vehicle within images captured at edge device 110 by cameras 112 in the manner described above with respect to entry detection module 212, except by using images and/or other data received at vehicle management server 130 as input, rather than being processed by edge device 110.

Model training module 338 trains the first machine-learning model to predict parameters of vehicles in the manner described above with respect to entry detection module 212. Parameter determination model training module may additionally train the first machine-learning model to predict direction of a vehicle. Parameter determination model training module may access training examples from training example database 354 and may store the models at model database 352. Similarly, model training module 338 may train the second machine-learning model using training examples stored at training example database 354 and may store the trained model at model database 352.

Event retrieval module 340 receives instructions from event matching module 218 to retrieve entry data from entry data database 358 that matches detected exit data, and returns at least partially matching data and/or a decision as to whether a match is found to event matching module 218. Event retrieval module 340 optionally stores the exit data to exit data database 360.

Profile database 356 stores profile data for vehicles that are encountered. For example, identifying information and/or license plate information may be used to index profile database 356. As a vehicle enters and exits facilities, profile database 356 may be populated with profiles for each vehicle that store those entry and exit events. Profiles may indicate owners and/or drivers of vehicles and may indicate contact information for those users. Event retrieval module 340 may retrieve contact information when an event is detected and may initiate communications with the user (e.g., welcome to managed facility message, or other information relating to usage of the facility).

The correction data collection module 370 is configured to collect correction data from the match resolution module 220 and the client device 140. As discussed above, some of the hanging events are automatically resolved by the match resolution module 220, and the remaining hanging events are manually resolved by users via the client device 140. When the hanging events are resolved, a hanging entry event and a hanging exit event are matched, and the identifier of the vehicle in one of the events must be corrected to be the same as the other event to form a match. This corrected identifier associated with the images captured during that event can be transformed into a new training example. The correction data collection module 370 collects and stores the correction data in the correction data database 366 and generates new training examples based on the correction data. These new training examples can then be stored with the training example database 354 and used to retrain the vehicle identification model. The retrained vehicle identification model can then be stored in the model database 352 and deployed onto the edge device 110 to detect identifiers of the license plate from incoming traffic.

The vehicle management server 130 may also include a prediction module 330. As a cloud computing system, the vehicle management server 130 is capable of receiving and processing large amounts of data. In some embodiments, the vehicle management server 130 receives data from edge devices 110 or client devices 140. The vehicle management server 130 may use this data with machine learning models to predict vehicular occupancy and vehicular duration at a managed facility. In some embodiments, the vehicle management server 130 applies additional machine learning models to predict vehicular occupancy and/or vehicular duration for a geographic region around the managed facility, long-term vehicular occupancy and/or vehicular duration, and short-term vehicular occupancy and/or vehicular duration.

In some embodiments, the vehicle management server 130 processes the large amounts of data to generate training data for the machine learning models. For example, the vehicle management server 130 may use data describing a number of vehicles at the managed facility to predict vehicular occupancy at the managed facility. For each time period, the vehicle management server 130 may label other data, such as data describing vehicles' routes to the managed facility or through the geographic region, weather data for the managed facility or geographic region, events occurring at the managed facility or in the region, characteristics of the managed facility, and the like, with the associated data describing the number of vehicles and train a demand machine learning model on the labeled data.

In another example, the vehicle management server 130 may use data describing parking instances at the managed facility to predict vehicular duration at the managed facility. A parking instance is an identifier of a parking session, which begins at entry to the managed facility and ends at exit from the managed facility. A continuous time range between entry and exit may be referred to as dwell time herein. For each parking instance of a vehicle, the vehicle management server 130 may label other data, such that described above, with associated data describing a dwell time of the vehicle and train a duration machine learning model on the labeled data. Though described in relation to parking, a parking instance may be used to represent any instance of a vehicle or other entity being continuously located at the managed facility.

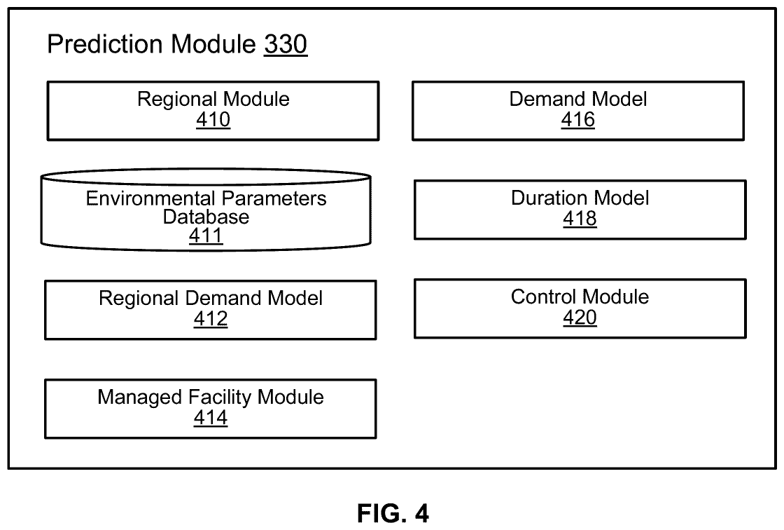

FIG. 4 illustrates an example architecture of prediction module 330, in accordance with one or more embodiments. As described above with respect to FIG. 3, the prediction module 330 implemented at the vehicle management server 130. In additional or alternative embodiments, the prediction module 330 may be implemented at an edge device 110 or client device 140 and/or may be implemented in a distributed manner across multiple computing resources.

The prediction module 330 includes a regional module 410, a regional demand model 412, managed facility module 414, a demand module 416, a duration model 418, and a control module 420. In some embodiments, the prediction module 330 includes additional or alternative modules or models to those shown in FIG. 4.

The regional module 410 predicts regional vehicular occupancies for geographic regions. A geographic region is an area of land and may be centered around a city, state, geographic point of interest (e.g., a national park, lake, etc.), and the like. The borders of the geographic region may correspond to a river, coastline, governmental-defined boundaries, and the like. For example, a geographic region corresponding to the city of Seattle may be defined by the boundary lines of the city dictated by the Washington state government. In some embodiments, the borders of a geographic region are pre-defined by an operator of the vehicle management server 130 or are indicated in a request for a predicted regional vehicular occupancy.

The regional module 410 receives requests for predictions from the control module 430. A request includes an identifier of a geographic region and a time range for the prediction to be made for. For instance, the request may indicate a desired prediction of regional vehicular occupancy of Seattle on Thanksgiving Day. In another example, the request may indicate a desired prediction for Yosemite National Park during the first week of May.

The regional module 410 retrieves regional environmental parameters that correspond to the geographic region from the environmental parameters database 411. The regional environmental parameters describe travel data, event data, location data, vehicular visit data, and visitor data for locations within a geographic region and may be received from cameras 112, sensors 118, edge devices 110, and/or client devices 140 connected to the vehicles management server 130 via the network 120.

The travel data describes the movement of vehicles within the geographic region. The travel data may include routes (e.g., movement from a starting location to an ending location) of vehicles within the geographic region. The routes may be entirely within the geographic region, may have at least one of the starting location or ending location of the route within the geographic region, or a may include a portion of the vehicle's movement within the geographic region. The travel data may also include for each vehicle that traveled within the geographic region, a time sequence for an identifier of the vehicle of the vehicle's position within the geographic region. The traffic data may also include aggregate travel statistics, projected traffic over forecasted time ranges, etc.

The event data describes historical events that have occurred or future events that are scheduled to occur in the geographic region. Each historical event may be associated with a venue (including the venue's location, capacity, etc.), a time period the event was held during, a date of the event, how many people attended the event, whether the event was on a holiday, and the like. For example, the event data may describe a Seahawks game held on at Lumen Field, which can host 68,740 visitors, on Thanksgiving Day with 67,000 people in attendance. In some embodiments, the parking lot of an event venue of an event may be a managed facility. Returning to the previous example, each parking garage at Lumen Field may be considered a managed facility that may be assessed by the managed facility module 414, as is described below.

The location data describes managed facilities and points of interest located within the geographic region. For managed facilities, the location data may describe what type of facility the managed facility is (e.g., a building, gym, parking lot, soccer field, etc.) and characteristics of people who visit the managed facility. For example, location data for a park may indicate that visitors tend to be athletic, have children, have dogs, and the like. A point of interest is a destination or landmark that people may want to visit. Examples of points of interest are restaurants, museums, historic sites, parks, fuel stations, tourist attractions, and stadiums. For a point of interest, the location data may describe aspects of the point of interest that attracts visitors to the point of interests. Examples include historical or cultural significance, natural beauty, entertainment, cuisine, educational value, and business needs.

The vehicular visit data describes visits of vehicles to locations within the geographic region. A visit occurs when a vehicle stops at a location. A visit may be defined by the stop occurring for at least a certain period of time, the vehicle stopping within a certain distance to the location, and/or the vehicle stopping at the location within a range of time corresponding to the average visit times of other vehicles. For example, a first car stopping at a stoplight next to a coffee shop would not be considered a visit to the coffee shop due to the length of time that the car was stopped and/or the proximity of the car to the coffee shop. In contrast, a second car parking at a parking lot in front of the coffee shop for five minutes would be considered a visit to the coffee shop. The vehicular visit data may also include, for each vehicle that visited the location, how many times the vehicle has visited the location and what dates the vehicle visited the location.

The visitor data describes visits to managed facilities within the geographic region. The visitor data for each vehicle that visited a managed facility may include a time and date of each visit. Each visit may further be associated with data describing when the vehicle arrived at the managed facility, when the vehicle left the managed facility, whether each visit was the first visit or a returning visit for the vehicle, an average amount of time the vehicle stays at the managed facility during each visit, a type of the vehicle (e.g., truck, sedan, particular brand, etc.), and the like. In some embodiments, the visitor data for a managed facility includes an amount of vehicles located at similar managed facilities to the managed facility over a set of time periods (e.g., each day, every hour, etc.), rates for using the managed facility during the time periods, types of vehicles visiting the managed facility during the time periods, and the like. Similar managed facilities have comparable aspects to the managed facility, may be located close to the managed facility, may associated with similar events to the managed facility, etc.

The regional module 410 inputs the time range from the request and the regional environmental parameters to a regional demand model 412. The regional demand model is trained to output a predicted measure of regional vehicular occupancy over a time period. Put another way, the regional demand model is trained to predict a number of vehicles that will be stopped at managed facilities within the region during the time range. The regional module 410 sends the predicted measure of regional vehicular occupancy to the control module 430. In some embodiments, the regional module 410 stores the predicted measure of regional vehicular occupancy in association with the input regional environmental parameters and time period in the environmental parameter database 411.

In some embodiments, the regional demand model 412 may be a statistical model that uses one or more statistical processes to predict regional vehicular occupancy. Examples of statistical models include linear models, logistic regression models, and time series models. In some embodiments, the regional demand model 412 is a machine learning model. For instance, the machine learning model may be a supervised model designed to understand the relationships between environmental parameters without being explicitly programmed with the relationships. Examples of machine learning models include decision trees, random forests, support vector machines, classifiers, and neural networks.

The regional module 410 may create training data for the regional demand model 412. The regional module 410 may retrieve environmental parameters for the geographic region from the environmental parameter database 411. For each location that a vehicle visited in the geographic region, the regional module 410 determines a number of vehicles visiting (e.g., stopped or parked) the location during each of a set of time windows. The time windows may be consecutive minutes, hours, days, weeks, etc. For each time window, the regional module 412 labels environmental parameters associated with the location and the time window with the number of vehicles. The regional module 410 uses the labeled environmental parameters as training data for the regional demand model 412. The regional module 410 may store the training data in the environmental parameter database 411 and create additional training data as more environmental parameters are stored to the environmental parameter database 411. The regional module 410 may retrain the regional demand model 412 on the additional training data at set time intervals, after a certain amount of additional training data has been created, upon receiving an indication from an operator, and the like. In some embodiments, the model training module 338 users the training data to train the regional demand model 412.

The managed facility module 414 predicts vehicular occupancies and occupancy durations for managed facilities. The managed facility module 414 receives requests for predictions from the control module 430. A request includes an identifier of the managed facility, a time range for the prediction to be made for, and a predicted measure of regional vehicular occupancy for the geographic region the managed facility is located in. For instance, the request may indicate a desired prediction of vehicular occupancy or occupancy duration of Discovery Park during work hours (e.g., 9 AM to 5 PM) in July. In another example, the request may indicate a desired prediction for vehicular occupancy of a grocery store parking lot on a Monday afternoon.

The managed facility module 414 retrieves environmental parameters that correspond to the managed facility. Like the regional environmental parameters, the environmental parameters describe travel data, event data, location data, vehicular visit data, and visitor data, but. However, the environmental parameters are specific to the managed facility rather than the entire geographic region. For instance, the travel data may describe routes to or from the managed facility and traffic conditions around the managed facility rather than within the geographic region of the managed facility.

To predict vehicular occupancy, the managed facility module 414 inputs the time range, the environmental parameters, and the predicted measure of regional vehicular occupancy to the demand model 416. The demand model 416 may be a statistical model or machine learning model that is trained to output a predicted measure of vehicular occupancy of a managed facility during a time range. Put another way, the demand model 416 is trained to predict a number of vehicles that will be at the managed facility during the time range. The managed facility module 414 sends the predicted measure of vehicular occupancy to the control module 430. In some embodiments, the managed facility module 414 stores the predicted measure of vehicular occupancy in association with the input environmental parameters, time period, and predicted measure of regional vehicular occupancy in the environmental parameter database 411.

The managed facility module 414 may create training data for the demand model 416. The managed facility module 414 may retrieve environmental parameters for the managed facility from the environmental parameter database 411. The managed facility module 414 determines a number of vehicles at (e.g., stopped or parked) the location during each of a set of time windows. The time windows may be consecutive minutes, hours, days, weeks, etc. For each time window, the managed facility module 414 labels the environmental parameters associated with the managed facility and the time window with the number of vehicles.

The managed facility module 414 uses the labeled environmental parameters as training data for the demand model 416. The managed facility module 414 may store the training data in the environmental parameter database 411 and create additional training data as more environmental parameters are stored to the environmental parameter database 411. The managed facility module 414 may retrain the demand model 416 on the additional training data at set time intervals, after a certain amount of additional training data has been created, upon receiving an indication from an operator, and the like. In some embodiments, the model training module 338 uses the training data to train the demand model 416.

To predict occupancy duration, the managed facility module 414 inputs the time range, the environmental parameters, and the predicted measure of regional vehicular occupancy to the duration model 418. The duration model 418 may be a statistical model or machine learning model that is trained to output a predicted measure of occupancy duration at a managed facility during a time range. Put another way, the duration model 418 is trained to predict an amount of time each vehicle will stay at the managed facility when visiting during the time range. The managed facility module 414 sends the predicted measure of occupancy duration to the control module 430. In some embodiments, the managed facility module 414 stores the predicted measure of occupancy duration in association with the input environmental parameters, time period, and predicted measure of regional vehicular occupancy in the environmental parameter database 411.

The managed facility module 414 may create training data for the duration model 418. The managed facility module 414 may retrieve environmental parameters for the managed facility from the environmental parameter database 411. The managed facility module 414 determines which environmental parameters correspond to parking instances of vehicles at the managed facility. The managed facility module 414 determines, for each parking instance, a set of environmental parameters that correspond to the same time period or geographic region of the parking instance. The managed facility module 414 labels the environmental parameters associated with each parking instance with the dwell time.

The managed facility module 414 uses the labeled environmental parameters as training data for the duration model 418. The managed facility module 414 may store the training data in the environmental parameter database 411 and create additional training data as more environmental parameters are stored to the environmental parameter database 411. The managed facility module 414 may retrain the duration model 418 on the additional training data at set time intervals, after a certain amount of additional training data has been created, upon receiving an indication from an operator, and the like. In some embodiments, the model training module 338 uses the training data to train the duration model 418.

The control module 420 receives requests for vehicular occupancy and/or occupancy duration predictions. In some embodiments, the requests are queries of whether to output a control signal that causes a specific action to occur at the managed facility. The control module 420 may determine whether the specific action is related to vehicular occupancy, occupancy duration, or both. For example, actions that block or unblock a section of physical space may be determined based on vehicular demand predictions (e.g., for high demand, make more physical space available, for low demand, make less physical space available, etc.). Actions that make resources that require a vehicle to remain at the managed facility for a threshold period of time, like vehicle chargers or fuel stations, may be determined based on occupancy duration predictions. Some actions may be determined based on both predictions—for example, to reduce power used for light in a parking garage when demand for parking is high (e.g., most spots are taken) but duration is long (e.g., the spots are being held overnight).

The control module 420 may receive the requests from one or more client devices 140 or edge devices 110. The control module 420 sends the requests to the regional module 410 and receives a corresponding output from the managed facility module 414. Requests may occur automatically (e.g., an automatic trigger on a time cadence that is regular or irregular, or responsive to an environmental condition being detected), where consideration of whether a control signal should be output is requested in an automatic request.

The control module 420 may send one or more notifications to a device that sent the request and/or client devices 140 associated with the managed facility. The notifications may indicate the vehicular occupancy and occupancy duration predictions. In some embodiments, the control module 420 may access a schedule of the managed facility and update the schedule based on the vehicular occupancy and occupancy duration predictions. For example, the control module 420 may reschedule events slotted for time periods that do not correspond to high vehicular occupancy and/or occupancy duration predictions for time periods that do correspond to high vehicular occupancy and occupancy duration predictions. In some embodiments, the control module 420 edits the schedule in response to the vehicular occupancy prediction and/or occupancy duration prediction being above a schedule threshold. The control module 420 may send notifications of the changes to the schedule to client devices 140 associated with the managed facility.

In some embodiments, the control module 420 may send one or more notifications indicative of the vehicular occupancy and/or occupancy duration predictions to client devices 140 associated with vehicles. The control module 420 may send notifications to client devices 140 with vehicles that were located at the managed facility recently (e.g., within a threshold amount of time), that are within a vicinity of the managed facility, that have visited the managed facility at a similar time of day to the time range, and the like. In some embodiments, the control module 420 sends the notifications in response to the vehicular occupancy and/or occupancy duration predictions for a time range being below one or more thresholds, and the notifications may indicate that vehicles that visit the managed facility during the time range are likely to find occupancy availability.

The control module 420 may send control signals indicative of one or more actions for machinery within the managed facility to complete based on the vehicular occupancy prediction and/or occupancy duration prediction. The control module 420 determines, based on the vehicular occupancy prediction and/or occupancy duration prediction, one or more actions to take to use resources effectively within the managed facility. The control module 420 may select actions that reduce or enlarge the physical space within the managed facility and/or make resources within the managed facility available in proportion to the vehicular occupancy prediction and/or occupancy duration prediction. For example, the control module 420 may select to unblock 90% of the physical space for a vehicular occupancy prediction of 90%. The actions facilitated by control signals may include causing a mechanical barrier to block or unblock a section of physical space, enable or disable power for lights or other electronic devices within a section, cause electronic signage to display information related to the predictions, and the like.

In some embodiments, the control module 420 may cause a sign to alter what is displayed. For example, the control module 420 may cause the sign to display the predicted measure of vehicular occupancy or occupancy duration of the managed facility or a numerical representation corresponding to the managed facility determined based on the predicted measure of vehicular occupancy or occupancy duration, such as a number of parking spaces expected to be available or an estimated wait time to find parking within the managed facility. In another example, the control module 420 may send a control signal that causes one or more of vehicle chargers to turn on or off to account for demand for charging within the managed facility and/or reduction of power used within the managed facility based on the predicted measure of vehicular occupancy or occupancy duration. For instance, the control signal may cause a subset of the changers to not receive power while the managed facility is unlikely to have much vehicular occupancy or may cause all of the chargers to receive power during a time period when the managed facility is likely to have a high (e.g., above a threshold) occupancy duration. In another example, the control module 420 may open or close floors of the managed facility based on the predicted measure of vehicular and disable resources that use power, such as lighting and ventilation, on the closed floors. The control module 420 may open or close floors by updating the sign, moving one or more gates, and the like.

In some embodiments, the control module 420 may receive a set of predicted vehicular occupancies and/or predicted occupancy durations from the managed facility module 414, where each predicted vehicular occupancy and/or predicted occupancy duration corresponds to a zone within managed facility. The control module 420 may select one or more zones with a respective predicted vehicular occupancy and/or predicted occupancy duration below a threshold and send control signals that cause machinery within the managed facility to guide vehicles to the one or more zones. For example, the control module 420 may determine that a seventh level of a parking garage has a predicted vehicular occupancy below a threshold or has the lowest predicted occupancy of the seven levels within the parking garage. To guide vehicles to the seventh level, the control module 420 may send control signals that cause mechanical barriers block off the first six levels, signs to display instructions for vehicles to move to the seventh level, turn off lights on the first six levels, and the like.

In some embodiments, the control module 420 may send one or more requests for predictions to the regional module 410. For instance, the control module 420 may be configured to send a request related to a managed facility and a current time period at set time intervals or in response to triggering events. Examples of triggering events include determining, based on sensor data from the managed facility, that a current number of vehicles at the managed facility is below or above a threshold. The control module 420 may continuously monitor the predictions determined based on these requests and send control signals as the predictions update. For example, the control module 420 may send a request based on sensor data indicating that the managed facility has a current vehicular occupancy over a threshold. The request may indicate the managed facility and a time period that starts at a current time and ends in an hour (or other set period of time). The control module 420 may receive predictions based on the request and send control signals that cause machinery to block off busy sections of the managed facility, enable vehicular charging, etc. The control module 420 may continuously or intermittently monitor the predictions for the managed facility and send control signals in real-time based on the predictions, where the “real-time” sending of control signals is within a time tolerance of when a request is sent.

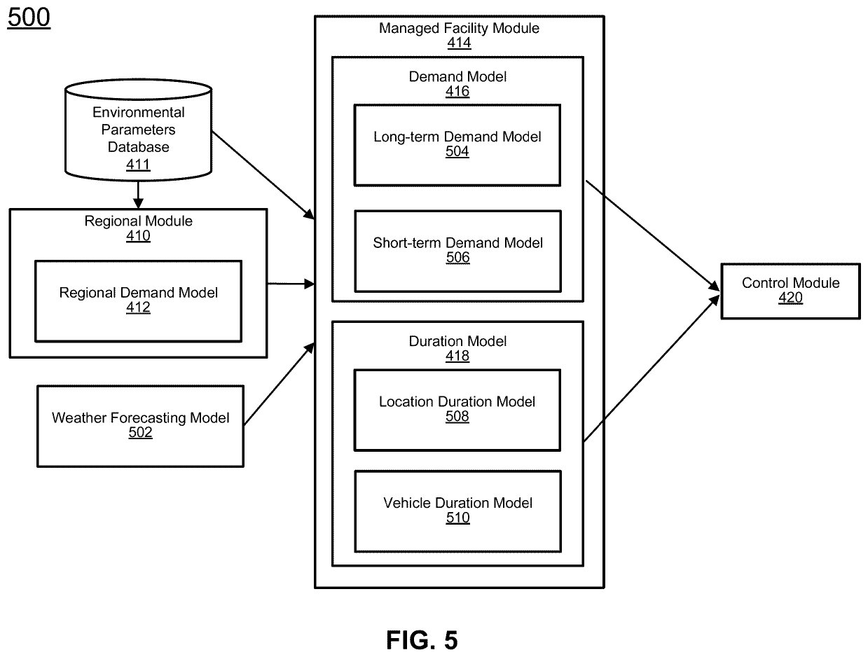

FIG. 5 illustrates an example flow 500 of a managed facility module being used to predict vehicular occupancy and vehicular duration, in accordance with one or more embodiments. In additional or alternative embodiments, different components or configurations of components may be used to predict vehicular occupancy and vehicular duration.

The regional module 410 retrieves regional environmental parameters that correspond to the geographic region from the environmental parameters database 411. The geographic region may be indicated in a request sent to the regional module 410, where the request also includes a managed facility within the geographic region and a time period. The regional environmental parameters describe travel data, event data, location data, vehicular visit data, and visitor data for locations within a geographic region. The regional module 410 inputs the regional environmental parameters and time period to a regional demand model 412, which outputs a predicted measure of regional vehicular occupancy during the time period. The regional module 410 sends the predicted measure of regional vehicular occupancy to the managed facility module 414. The regional module 410 may also send the request to the managed facility module 414.

The managed facility module 414 retrieves environmental parameters that correspond to the managed facility in the request from the environmental parameters database 411. The environmental parameters describe travel data, event data, location data, vehicular visit data, and visitor data for the managed facility. The managed facility module 414 also receives weather data from a weather forecasting model 502 the is configured to predict weather corresponding to locations within geographic regions over a set of time periods. In some embodiments, the managed facility module 414 requests weather data corresponding to the geographic region and/or location of the managed facility during the time period from the weather forecasting model 502.

The managed facility module 414 inputs the predicted measure of regional vehicular occupancy, environmental parameters, and time period to the demand model 416. The demand model 416 outputs a predicted measure of vehicular occupancy at the managed facility for the time period. The demand model 416 includes a long-term demand model 504 and a short-term demand model 506. The long-term demand model 504 may be a statistical model or machine learning model trained to predict a vehicular occupancy at the managed facility for long-term time periods (e.g., those longer than a year). The short-term demand model 506 may be a statistical model or machine learning model trained to predict vehicular occupancy at the managed facility for short-term time periods (e.g., those shorter than a day). The designation between a time period that is long-term and a time period that is short-term may be selected by an operator.

The long-term demand model 504 and a short-term demand model 506 may be trained by the managed facility module 414 similar to the training of the demand model 416. For instance, the long-term demand model 504 may be trained on sets of environmental parameters corresponding to long-term time windows and labeled with the number of vehicles at the managed facility in that time window, and the short-term demand model 506 may be trained on sets of environmental parameters corresponding to short-term time windows and labeled with the number of vehicles at the managed facility in that time window. This training enables the long-term demand model 504 to understand patterns in demand that occur over long-term time periods and the short-term demand model 506 to understand patterns in demand that occur over short-term time periods.

The managed facility module 414 inputs the predicted measure of regional vehicular occupancy, environmental parameters, and time period to the duration module 418. The duration module 418 outputs a predicted measure of occupancy duration at the managed facility for the time period. The duration module 418 includes a location duration model 508 and a vehicle duration model 510. The location duration model 508 may be a statistical model or machine learning model trained to predict an occupancy duration for each managed facility over a set of time increments (e.g., hours, days, etc.). The location duration model 508 may output a predicted occupancy duration for the managed facility or for an aggregate of managed facilities in the geographic region. The vehicle duration model 510 may be a statistical model or machine learning model trained to predict occupancy duration for individual vehicles at managed facilities over a set of time increments. The individual duration model 510 may output a predicted occupancy duration for a specific individual or for an aggregate of individuals that have gone to the managed facilities in the geographic region.

The location duration model 508 and a vehicle duration model 510 may be trained by the managed facility module 414 similar to the training of the duration model 418. For instance, the location duration model 508 may be trained on sets of environmental parameters where each set corresponds to a managed facility and a time increment and is labeled with a dwell time of vehicles at the managed facility during the time increment. The vehicle duration model 510 may be trained on sets of environmental parameters where each set corresponds to a vehicle and a time increment and is labeled with a dwell time of the vehicle at any managed facility during the time increment. This training enables the location duration model 508 to understand patterns in duration that occur on a facility-by-facility basis and the vehicle duration model 510 to understand patterns in duration at an individual vehicle level.

The managed facility module 414 sends the predicted long-term vehicular occupancy, predicted short-term vehicular occupancy, predicted location occupancy duration, and predicted vehicle occupancy duration to the control module 420. The managed facility module 414 may maximize a function using the predictions in order to achieve a goal input by an operator. The goal may pertain to the managed facility and describe a desired allocation of resources at the managed facility. For example, the goal may be to reduce waste in the form of resources powered at the managed facility when not in use, and the control module 420 may determine function that represents power usage at the managed facility based on vehicular occupancy and/or occupancy duration. The control module 420 may determine actions for machinery and other resources within the managed facility to take based on the maximized functions.

In some embodiments, the control module 420 compares the predictions to one or more thresholds and, in response to one or more predictions exceeding a threshold, may send control signals that cause mechanical barriers to lift (providing vehicular access to a section of the managed facility), vehicle chargers to be powered, electronic devices within a section of the managed facility to be powered, robots within the managed facility to move to particular stations within the managed facility, and the like during the time period. In some embodiments, in response to one or more predictions not meeting a threshold, the managed facility module 414 may send control signals that cause mechanical barriers to lower (restricting vehicular access to a section of the managed facility), vehicle chargers to turn off, electronic devices within a section of the managed facility to turn, robots within the managed facility to move to particular stations (such as a charging station) within the managed facility, and the like.

In some embodiments, the control module 420 may send control signals indicating for the machinery to take different actions at different times within the time period based on the long-term vehicular occupancy and occupancy durations being above a set of thresholds and the short-term vehicular occupancy and occupancy durations being below a set of thresholds (e.g., indicating that the managed facility is likely to be busy in the long-term but not in the short-term) or vice versa. In additional or alternative embodiments, the control module 420 may send notifications indicating the long-term and short-term vehicular occupancy and occupancy durations to client devices 140 associated with the managed facility.

### Example Computer System

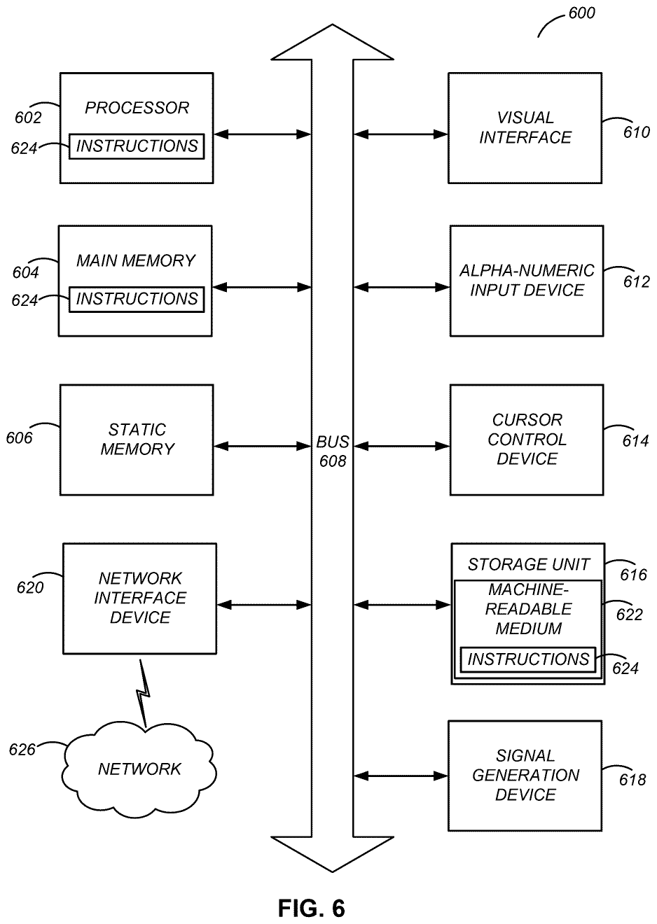

FIG. 6 is a block diagram illustrating components of an example machine able to read instructions from a machine-readable medium and execute them in a processor (or controller). FIG. (FIG. 6 is a block diagram illustrating components of an example machine able to read instructions from a machine-readable medium and execute them in a processor (or controller). Specifically, FIG. 6 shows a diagrammatic representation of a machine in the example form of a computer system 600 within which program code (e.g., software) for causing the machine to perform any one or more of the methodologies discussed herein may be executed. The program code may be comprised of instructions 624 executable by one or more processors 602. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The machine may be a computing system capable of executing instructions 624 (sequential or otherwise) that specify actions to be taken by that machine. Further, while only a single machine is illustrated, the term “machine” shall also be taken to include any collection of machines that individually or jointly execute instructions 624 to perform any one or more of the methodologies discussed herein.

The example computer system 600 includes one or more processors 602 (e.g., a central processing unit (CPU), a graphics processing unit (GPU), a digital signal processor (DSP), one or more application specific integrated circuits (ASICs), one or more radio-frequency integrated circuits (RFICs), field programmable gate arrays (FPGAs)), a main memory 604, and a static memory 606, which are configured to communicate with each other via a bus 608. The computer system 600 may further include visual display interface 610. The visual interface may include a software driver that enables (or provide) user interfaces to render on a screen either directly or indirectly. The visual interface 610 may interface with a touch enabled screen. The computer system 600 may also include input devices 612 (e.g., a keyboard a mouse), a cursor control device 614, a storage unit 616, a signal generation device 618 (e.g., a microphone and/or speaker), and a network interface device 620, which also are configured to communicate via the bus 608.

The storage unit 616 includes a machine-readable medium 622 (e.g., magnetic disk or solid-state memory) on which is stored instructions 624 (e.g., software) embodying any one or more of the methodologies or functions described herein. The instructions 624 (e.g., software) may also reside, completely or at least partially, within the main memory 604 or within the processor 602 (e.g., within a processor's cache memory) during execution.

### Example Methods for Vehicle Identification

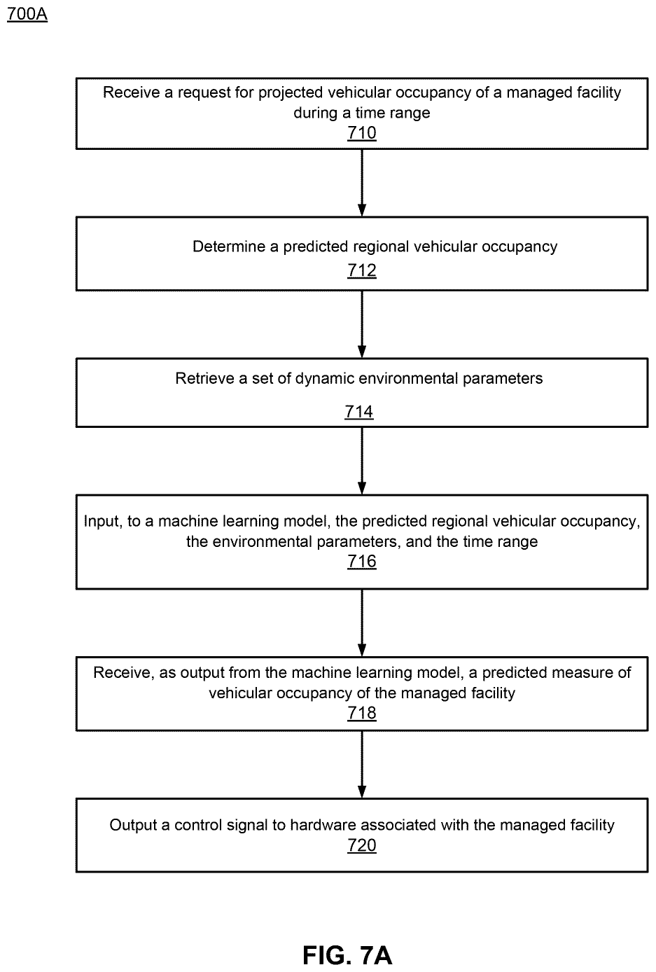

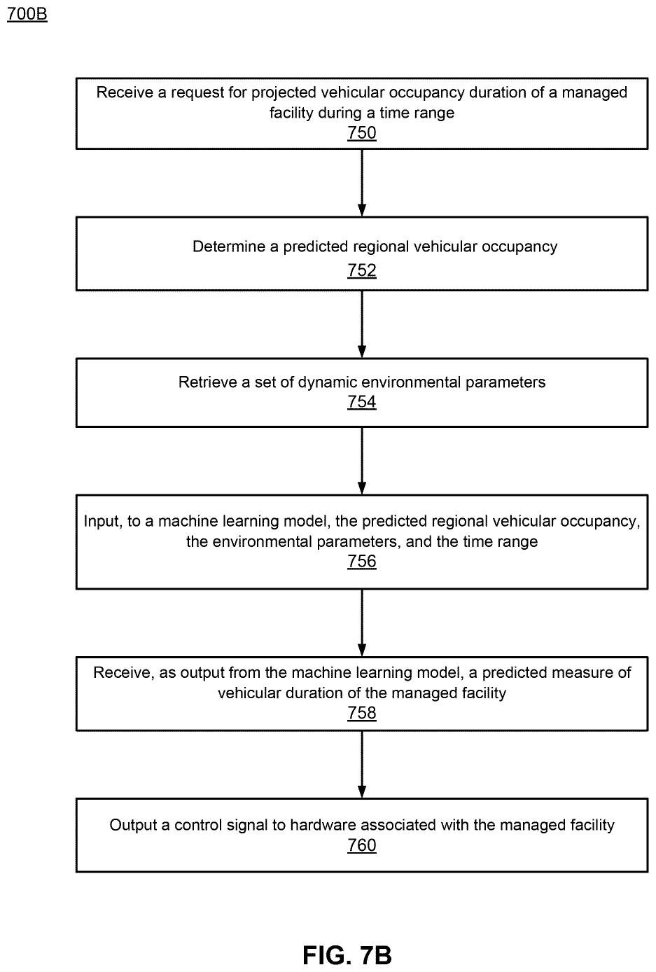

FIG. 7A is a flowchart 700A of an example method for predicting vehicular occupancy for a managed facility, in accordance with one or more embodiments. Alternative embodiments may include more, fewer, or different steps from those illustrated in FIG. 7A, and the steps may be performed in a different order from that illustrated in FIG. 7A. Method 700A may be executed by one or more processors of a system, which may include an edge device 110, a vehicle management server 130, and/or a client device 140. The one or more processors may include processor 602 of edge device 110 and/or of vehicle management server 130 executing instructions (e.g., instructions 624) that cause one or more modules to perform their respective operations.

The managed facility module 414 receives 710 receives a request for predicted vehicular occupancy of a managed facility during a time range. The regional module 410 determines 712 a predicted regional vehicular occupancy within a geographic region encompassing the managed facility during the range of time. The regional environmental parameters may dynamically update to reflect current conditions of the geographic region and include traffic data representative of vehicles routing to the geographic region, event data representative of events scheduled to occur within the geographic region during at least a portion of the time range, points of interest located within the geographic region, and/or historical visit data representative of vehicles that visited a location in the geographic region, where each visit is associated with a dwell time at the visited location. In some embodiments, the regional module 410 inputs regional environmental parameters, which correspond to the geographic region, and the time range to the regional demand model 412 and receives the predicted regional vehicular occupancy of the geographic region from the regional demand model 412.

The managed facility module 414 may train the regional demand model 412. For instance, the managed facility module 414 may receive vehicle data associated with a plurality of vehicles previously located within the geographic region and determine a number of vehicles parked at each of a set of locations associated with the plurality of vehicles during each of a set of time windows. The vehicle data of a vehicle may include routes of the vehicle, locations within the geographic region that the vehicle was parked at, time ranges the vehicle was parked within the geographic region, dates the vehicle was parked within the geographic region, and a number of times the vehicle has visited each of the locations. The managed facility module 414 generates training data by labeling vehicle data associated with each location during each time window with the number of vehicles parked at the location during the time window. The managed facility module 414 trains the regional demand model 412 on the training data.

The managed facility module 414 retrieves 714 a set of dynamic environmental parameters corresponding to the managed facility and inputs 716 the predicted regional vehicular occupancy, the environmental parameters, and the time range to the demand model 416. The managed facility module 414 receives 718 a predicted measure of vehicular occupancy of the managed facility during the time range from the demand model 416. The control module 420 outputs 720 a control signal instructing a device (e.g., edge device 110, gate 114, sensor 118, etc.) associated with the managed facility to perform an operation based on the predicted measure of vehicular occupancy of the managed facility.

In some embodiments, the managed facility module 414 the regional environmental parameters to correspond to a location of the managed facility within the geographic region. The managed facility module 414 30 may input the filtered regional environmental parameters to the demand model 416 with the predicted regional vehicular occupancy and the time range.

In some embodiments, the managed facility module 414 receives vehicle data associated with plurality of vehicles previously located at the managed facility. The vehicle data may include routes of the vehicle, time ranges the vehicle was located at the managed facility, dates the vehicle was located at the managed facility, and a number of times the vehicle has visited the managed facility. The managed facility module 414 determines a number of vehicles located at the managed facility during each of a plurality of time window. The managed facility module 414 generates training data by labeling, for each time window, vehicle data associated with vehicles located at the managed facility during the time window. The managed facility module 414 trains the demand model 416 on the training data.

In some embodiments, the demand model 416 includes the long-term demand model 504 and short-term demand model 506 and the predicted measure of vehicular occupancy of the managed facility includes a predicted long-term vehicular occupancy and a predicted short-term vehicular occupancy. The control module 420 receives the long-term vehicular occupancy of the managed facility from the long-term demand model 504, which is trained on vehicle data captured within an hour-long time window. The control module 420 receives the short-term vehicular occupancy of the managed facility from the short-term demand model 506, which is trained on vehicle data captured within a week-long time window. In some embodiments, the control module 420compares the short-term vehicular occupancy to the long-term vehicular occupancy. In response to determining the short-term vehicular occupancy is less than the long-term vehicular occupancy, control module 420 outputs the control signal to instruct a mechanical barrier within the managed facility to block off a section of the managed facility from vehicles.

In some embodiments, the control module 420 determines that the managed facility has more vehicular occupancy available than needed for the predicted measure of vehicular occupancy of the managed facility and outputs the control signal to mechanical barrier within the managed facility, such that the control signal causes the mechanical barrier to block off a section of the managed facility from vehicles.

In some embodiments, the control module 420 outputs the control signal to a sign configured to display information about the managed facility, and the control signal causes the sign to alter what is displayed based on the predicted measure of vehicular occupancy of the managed facility.

In some embodiments, in response to determining that the predicted measure of vehicular occupancy below a threshold amount, the control module 420 outputs the control signal to a set of vehicle chargers, such that the control signal causes the vehicle chargers to turn off or on.

In some embodiments, in response determining the predicted measure of vehicular occupancy is above a threshold amount, the control module 420 outputs the control signal to a set of robotic vehicle chargers, which causes the robotic vehicle chargers to move to a designated location within the managed facility.

In some embodiments, the control module 420 sends an instruction to a mobile application. The instruction causes a user interface presented by the mobile application to display an indication of the predicted measure of vehicular occupancy of the managed facility.

In some embodiments, the managed facility module 414 inputs the predicted regional vehicular occupancy, the environmental parameters, and the time range to the duration model 418 and receives a predicted measure of occupancy duration of vehicles at the managed facility during the time range from the duration model 418. The managed facility module 414 inputs the predicted measure of occupancy duration and the predicted measure of vehicular occupancy to a machine learning model, which outputs data used to determine an aspect of the control signal. For example, the machine learning model may output one or more actions for machinery of the managed facility to take during the time period, and the control module 420 creates control signals that cause the machinery to take the one or more actions.

FIG. 7B is a flowchart of a method 700B for outputting a control signal based on a predicted measure of vehicular duration at a managed facility, in accordance with one or more embodiments. Alternative embodiments may include more, fewer, or different steps from those illustrated in FIG. 7B, and the steps may be performed in a different order from that illustrated in FIG. 7B. Method 700B may be executed by one or more processors of a system, which may include an edge device 110, a vehicle management server 130, and/or a client device 140. The one or more processors may include processor 602 of edge device 110 and/or of vehicle management server 130 executing instructions (e.g., instructions 624) that cause one or more modules to perform their respective operations.

The managed facility module 414 receives 750 a request for projected vehicular duration at a managed facility during a time range. The regional module 410 determines 752 a predicted regional vehicular occupancy within a geographic region encompassing the managed facility during the time range. For instance, the regional module 410 may input regional environmental parameters, which correspond to the geographic region, and the time range to the regional demand model 412. The regional environmental parameters may dynamically update to reflect current conditions of the geographic region and include traffic data representative of vehicles routing to the geographic region, event data representative of events scheduled to occur within the geographic region during at least a portion of the time range, points of interest located within the geographic region, and historical visit data representative of vehicles that visited a location in the geographic region, where each visit is associated with a dwell time at the visited location. The regional module 410 receives, as output from the regional demand model 412, the predicted regional vehicular occupancy of the geographic region during the time range.

In some embodiments, the managed facility module 414 trains the regional duration model 412. The managed facility module 414 receives vehicle data associated with a plurality of vehicles previously located within the geographic region. The vehicle data for a vehicle may include routes of the vehicle, locations within the geographic region that the vehicle was parked at, time ranges the vehicle was parked within the geographic region, dates the vehicle was parked within the geographic region, and a number of times the vehicle has visited each of the one or more locations. The managed facility module 414 determines a number of vehicles parked at each of a set of location during each of a set of time windows. The managed facility module 414 generates training data by labeling, for each location during each time window, vehicle data associated with the location with the number of vehicles parked at the location during the time window and trains the regional demand model 412 on the training data.

The managed facility module 414 retrieves 754 a set of dynamic environmental parameters corresponding to the managed facility. In some embodiments, the managed facility module 414 filters regional environmental parameters to correspond to a location of the managed facility within the geographic region and uses the filtered environmental parameters as the environmental parameters. The managed facility module 414 inputs 756 the predicted regional vehicular occupancy, the environmental parameters, and the time range to the duration model 418 and receives 758 a predicted measure of vehicular duration at the managed facility during the time range from the duration model 418.

In some embodiments, the managed facility module 414 may train the duration model 418. The managed facility module 414 may receive vehicle data associated with a plurality of parking instances of vehicles previously located at the managed facility for a continuous period of time and determine a dwell time of how long the vehicle was continuously located at the managed facility during each parking instance. The managed facility module 414 generates training data by labeling, for each parking instance of each vehicle, vehicle data associated with the parking instance with the determined dwell time and trains the duration model 418 on the training data.

The control module 420 outputs 760 a control signal instructing a device associated with the managed facility to perform an operation based on the predicted measure of vehicular duration at the managed facility. In some embodiments, the control module 420 outputs the control signal in response to determining the short-term predicted duration is less than the long-term predicted duration, where the control signal instructs a mechanical barrier within the managed facility to block off a section of the managed facility from vehicles. In some embodiments, the control module 420 may estimate that the managed facility will run out of vehicular occupancy available for a time window and, in response, output the control signal to a mechanical barrier within the managed facility, causing the mechanical barrier to block off a section of the managed facility from vehicles. In some embodiments, the control module 420 outputs the control signal to a sign configured to display information about the managed facility, causing the sign to display an indication of the predicted measure of vehicular duration at the managed facility.

In some embodiments, the duration model 418 includes the location duration model 508 and the vehicle duration model 510. The managed facility module 414 receives a predicted location occupancy duration from the location duration model 508. The managed facility module 414 also receives a predicted vehicle occupancy duration at the managed facility from the vehicle duration model 510. The control module 420may use the predicted location occupancy duration at the managed facility and the predicted vehicle occupancy duration at the managed facility to determine one or more control signals to send.

In some embodiments, the control module 420 outputs the control signal to a set of vehicle chargers, causing the vehicle chargers to turn on or off in response to determining the predicted measure of vehicular duration is below a threshold amount. In some embodiments, the control module 420 determines that the predicted measure of vehicular duration is above a threshold amount and, in response, outputs the control signal to a set of robotic vehicle chargers, causing the robotic vehicle chargers to move to a designated location within the managed facility. In some embodiments, in addition to or instead of sending a control signal, the control module 420 sends an instruction to display an indication of the predicted measure of vehicular duration of the managed facility via a user interface presented by a mobile application.

In some embodiments, the managed facility module 414 inputs the predicted regional vehicular occupancy, the environmental parameters, and the time range to the demand model 416 and receives a predicted measure of occupancy of vehicles at the managed facility during the time range from the demand model 416. The managed facility module 414 inputs the predicted measure of occupancy and the predicted measure of vehicular duration to a machine learning model, which outputs data used to determine an aspect of the control signal. For example, the machine learning model may output one or more actions for machinery of the managed facility to take during the time period, and the control module 420 creates control signals that cause the machinery to take the one or more actions.

### ADDITIONAL CONFIGURATION CONSIDERATIONS

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium and processor executable) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module is a tangible component that may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

Upon reading this disclosure, those of skill in the art will appreciate still additional alternative structural and functional designs for a system and a process for seamless entry and exit to a managed facility blocked by a moveable gate through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method for forecasting parking demand, comprising:
receiving a request for predicted vehicular occupancy of a managed facility during a time range;
determining a predicted regional vehicular occupancy within a geographic region encompassing the managed facility during the range of time;
retrieving a set of dynamic environmental parameters corresponding to the managed facility;
inputting, to a machine learning model, the predicted regional vehicular occupancy, the environmental parameters, and the time range;
receiving, as output from the machine learning model, a predicted measure of vehicular occupancy of the managed facility during the time range; and
outputting a control signal instructing a device associated with the managed facility to perform an operation based on the predicted measure of vehicular occupancy of the managed facility.

2. The method of claim 1, wherein determining the predicted regional vehicular occupancy within the geographic region encompassing the managed facility during the range of time comprises:
inputting, to a second machine learning model, regional environmental parameters and the time range, wherein the regional environmental parameters correspond to the geographic region; and
receiving, as output from the second machine learning model, the predicted regional vehicular occupancy of the geographic region during the time range.

3. The method of claim 2, wherein the second machine learning model is trained by:
receiving vehicle data associated with a plurality of vehicles previously located within the geographic region;
determining, for each of one or more locations associated with the plurality of vehicles, a number of vehicles parked at the location during each of a set of time windows;
generating training data by labeling, for each location during each time window, vehicle data associated with the location with the number of vehicles parked at the location during the time window; and
training the second machine learning model on the training data.

4. The method of claim 3, wherein the vehicle data for each vehicle of the plurality includes one or more of:
one or more routes of the vehicle,
one or more locations within the geographic region that the vehicle was parked at,
one or more time ranges the vehicle was parked within the geographic region,
one or more dates the vehicle was parked within the geographic region, and
a number of times the vehicle has visited each of the one or more locations.

5. The method of claim 2, wherein the regional environmental parameters dynamically update to reflect current conditions of the geographic region and include one or more of:
traffic data representative of vehicles routing to the geographic region,
event data representative of events scheduled to occur within the geographic region during at least a portion of the time range,
points of interest located within the geographic region, and
historical visit data representative of vehicles that visited a location in the geographic region, each visit associated with a dwell time at the visited location.

6. The method of claim 2, further comprising:
filtering the regional environmental parameters to correspond to a location of the managed facility within the geographic region; and
inputting the filtered regional environmental parameters to the machine learning model with the predicted regional vehicular occupancy and the time range.

7. The method of claim 1, further comprising:
receiving vehicle data associated with plurality of vehicles previously located at the managed facility;
determining, for each of a plurality of time windows, a number of vehicles located at the managed facility during the time window;
generating training data by labeling, for each time window, vehicle data associated with vehicles located at the managed facility during the time window; and
training the machine learning model on the training data.

8. The method of claim 7, wherein the vehicle data for each vehicle of the plurality includes one or more of:
one or more routes of the vehicle,
one or more time ranges the vehicle was located at the managed facility,
one or more dates the vehicle was located at the managed facility, and
a number of times the vehicle has visited the managed facility.

9. The method of claim 1, wherein the machine learning model includes a first sub-model and a second sub-model, the method further comprising:
receiving, from the first sub-model, a short-term predicted usage of the managed facility, the first sub-model trained on vehicle data captured within an hour-long time window; and
receiving, from the second sub-model, a long-term predicted usage of the managed facility, the second sub-model trained on vehicle data captured within a week-long time window;
wherein the predicted measure of vehicular occupancy of the managed facility includes the short-term predicted usage and the long-term predicted usage.

10. The method of claim 9, wherein outputting the control signal instructing the device associated with the managed facility to perform the operation based on the predicted measure of vehicular occupancy of the managed facility comprises:
in response to determining the short-term predicted usage is less than the long-term predicted usage, outputting the control signal instructing a mechanical barrier within the managed facility to block off a section of the managed facility from vehicles.

11. The method of claim 1, further comprising:
determining, based on the predicted measure of vehicular occupancy of the managed facility, that the managed facility has more vehicular occupancy available than needed for the predicted measure of vehicular occupancy; and
outputting the control signal to a mechanical barrier within the managed facility, wherein the control signal causes the mechanical barrier to block off a section of the managed facility from vehicles.

12. The method of claim 1, further comprising:
outputting the control signal to a sign configured to display information about the managed facility, wherein the control signal causes the sign to alter what is displayed based on the predicted measure of vehicular occupancy of the managed facility.

13. The method of claim 1, further comprising:
responsive to determining the predicted measure of vehicular occupancy is below a threshold amount, outputting the control signal to a set of vehicle chargers, wherein the control signal causes one or more of the vehicle chargers to turn off.

14. The method of claim 1, further comprising:
responsive to determining a predicted measure of vehicular occupancy above a threshold amount, outputting the control signal to a set of robotic vehicle chargers, wherein the control signal causes one or more of the robotic vehicle chargers to move to a designated location within the managed facility.

15. The method of claim 1, further comprising:
sending, to a mobile application, an instruction to display an indication of the predicted measure of vehicular occupancy of the managed facility via a user interface presented by the mobile application.

16. The method of claim 1, further comprising:
inputting, to a second machine learning model, the predicted regional vehicular occupancy, the environmental parameters, and the time range;
receiving, as output from the second machine learning model, a predicted measure of occupancy duration of vehicles at the managed facility during the time range;
inputting, to a third machine learning model, the predicted measure of occupancy duration and the predicted measure of vehicular occupancy; and
receiving an output from the third machine learning model, wherein the output is used to determine an aspect of the control signal.

17. A non-transitory computer-readable medium comprising memory with instructions encoded thereon, the instructions comprising instructions to cause one or more processors to perform steps comprising:
receiving a request for predicted vehicular occupancy of a managed facility during a time range;
determining a predicted regional vehicular occupancy within a geographic region encompassing the managed facility during the range of time;
retrieving a set of dynamic environmental parameters corresponding to the managed facility;
inputting, to a machine learning model, the predicted regional vehicular occupancy, the environmental parameters, and the time range;
receiving, as output from the machine learning model, a predicted measure of vehicular occupancy of the managed facility during the time range; and
outputting a control signal instructing a device associated with the managed facility to perform an operation based on the predicted measure of vehicular occupancy of the managed facility.

18. The non-transitory computer-readable medium of claim 17, wherein determining the predicted regional vehicular occupancy within the geographic region encompassing the managed facility during the range of time comprises:
inputting, to a second machine learning model, regional environmental parameters and the time range, wherein the regional environmental parameters correspond to the geographic region; and
receiving, as output from the second machine learning model, the predicted regional vehicular occupancy of the geographic region during the time range.

19. A system comprising:
memory with instructions encoded thereon; and
one or more processors that, when executing the instructions, are caused to perform operations comprising:
receiving a request for predicted vehicular occupancy of a managed facility during a time range;
determining a predicted regional vehicular occupancy within a geographic region encompassing the managed facility during the range of time;
retrieving a set of dynamic environmental parameters corresponding to the managed facility;
inputting, to a machine learning model, the predicted regional vehicular occupancy, the environmental parameters, and the time range;
receiving, as output from the machine learning model, a predicted measure of vehicular occupancy of the managed facility during the time range; and
outputting a control signal instructing a device associated with the managed facility to perform an operation based on the predicted measure of vehicular occupancy of the managed facility.

20. The system of claim 19, wherein the system receives a request in response to a triggering event and the control signal is output in real-time.
